(19) United States
(12) Patent Application Publication
(10) Pub. No.: US 2006/0238661 A1
(43) Pub. Date: Oct. 26, 2006

(54) Mounting system capable of adjusting viewing angle of a monitor

(76) Inventor: Sung I. Oh, West Covina, CA (US)

Correspondence Address: SUNG I. OH, PROFESSIONAL LAW CORPORATION, 710 QUAIL VALLEY LANE, WEST COVINA, CA, 91791, US

(21) Appl. No.: 11/353,741

(22) Filed: Feb. 13, 2006

Related U.S. Application Data
(60) Provisional application No. 60/652,685, filed on Feb. 14, 2005.
(60) Provisional application No. 60/663,819, filed on Mar. 21, 2005.
(60) Provisional application No. 60/667,715, filed on Mar. 31, 2005.

(51) Int. Cl. H04N 5/645

(52) U.S. Cl. 348/825

(57) ABSTRACT

A mounting system is capable of adjusting the viewing angle of a monitor. The mounting system includes at least two sets of beams between a first mounting structure and a second mounting structure. The first mounting structure may be adapted to attach to a wall, and the second mounting structure may be adapted to couple to a monitor such as a plasma or LCD television. Each of the two sets of beams may be coupled to a motor so that the two sets of beams may extend or retract independently to move the second mounting structure relative to the first mounting structure, thereby adjusting the viewing angle of the monitor. The mounting system may include a remote control to send control signals to tilt or move the monitor laterally. The remote control may have a preset button to remember a predetermined position of the monitor, so that activation of the preset button causes the mounting system to move the monitor to the predetermined position.

### RELATED APPLICATIONS

This application claims priority to three provisional application Ser. Nos.: (1) 60/652,685 filed Feb. 14, 2005; (2) 60/663,819 filed Mar. 21, 2005; and (3) 60/667,715 filed Mar. 31, 2005, which are all incorporated by reference.

### FIELD OF THE INVENTION

This invention is directed to a mounting system capable of adjusting the position of an apparatus relative to a reference plane. In particular, the mounting system is capable of mounting a monitor to a surface, such as a wall, and adjusting the viewing angle of the monitor either manually or based on an input signal from a remote control.

### BACKGROUND OF THE INVENTION

Flat panel monitors such as computer monitors, TFT, LCD, plasma, slim televisions, and the like (collectively referred to as “monitor(s)”) are becoming popular because they can be mounted onto a wall to save floor space and for their aesthetically pleasing appearance. In particular, monitors are generally mounted to a wall with a mechanical support arm or a bracket then fixed in a desired orientation to maximize the viewing angle of the monitor. To later adjust the viewing angle of the monitor, however, a viewer generally tilts the monitor manually to a new viewing angle so that the viewer may more comfortably view the monitor from a different location or to deflect a glare on the monitor away from the viewer. For instance, a monitor may be fixed to a wall in a family room to allow the family members or one viewer to view the monitor at the desired viewing angle. As the viewer moves from one area to another area, such as from the family room to the kitchen, the viewer may not be able to view the monitor. In addition, in situations where the monitor is mounted in a remote location or high above the floor, it may be inconvenient for the viewer to adjust the viewing angle of the monitor.

Another limitation with the support arm is that there is a limit as to how much weight the support arm can handle. That is, as the support arm is extended to support a monitor further away from the wall, the weight of the monitor applies bending load on the support arm. The bending load on the support arm increases as the distance between the monitor and the wall increases. Bending loads can apply extreme stress on the support arm. As such, with heavier monitors, support arms are not generally used. Rather, wall mounts are used to attach the heavier monitors to a wall with the viewing angle fixed at a predetermined orientation. The wall mounts do allow for some tilting of the monitor but do not allow the monitor to be moved laterally or extend out from the wall. Accordingly, there is a need for a mounting system that can mount a larger and heavier monitor to a wall and allow the viewing angle of the monitor to be more easily adjusted.

### SUMMARY OF THE INVENTION

This invention is directed to a mounting system capable of adjusting the orientation of a second mounting structure relative to a first mounting structure. The mounting system includes a first set of beams and a second set of beams, where the first and second sets of beams are between the second mounting structure and the first mounting structure. With regard to orientation, when the second mounting structure is substantially flush with the first mounting structure, the second mounting structure and the first mounting structure may be on a XY plane, and as the second mounting structure extend from the first mounting structure, the second mounting structure may extend in the positive Z axis. The first and second set of beams may have first ends pivotally coupled to the second mounting structure and the second ends of the beams may be able to move or slide substantially along a predetermined path on the first mounting structure. This allows the second mounting structure to be orientated in a variety of ways relative to the first mounting structure. For instance, the second mounting structure may be extended along the positive Z-axis, and move laterally along the XY plane, i.e., move to the left, right, up, and down substantially parallel relative to the first mounting plate. In addition, the second mounting structure may tilt in the XZ plane and YZ plane relative to the first mounting structure. For instance, the YZ plane may be considered as a first plane and the XZ plane may be represented as a second plane.

The mounting system may also include one or more motors to move the second ends of the beams substantially along the predetermined path formed substantially along the first mounting structure. The mounting system includes a processor to control the motors to allow the motors to move the respective ends of the beams along a positive or negative direction along the predetermined path. The processor may receive instructions from a remote control to move the second mounting structure from a first position to a second position. This way, a user may adjust the second mounting structure relative to the first mounting structure remotely. Alternatively, a predetermined movement of the second mounting structure relative to the first mounting structure may be programmed into a memory so that the second mounting structure may move in accordance with the predetermined movement programmed into the memory. Alternatively, the second mounting structure may be moved manually without the assistance of the motors.

The mounting system may be used in a variety of application such as to adjust the viewing angle of a monitor. The mounting structure may be attached to a wall to allow a view to adjust the viewing angle of the monitor remotely. The mounting system may be also used in the billboard application as well where the billboard may be moved in accordance with the predetermined movements preprogrammed into the memory. In general, the mounting system may be used in applications where control movement between two mounting structures is desired. The mounting system may be mounted to a floor or ceiling as well.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a mounting system capable of adjustably orientating a second mounting structure relative to a first mounting structure with references to X, Y, and Z axes.

FIG. 2 shows the mounting system of FIG. 1 in the XZ plane.

FIG. 3 shows the mounting system of FIG. 1 in the YZ plane.

FIG. 4 is a front view of the first mounting structure shown in FIG. 1.

FIGS. 5A and 5B show cross-sectional views of a sleeve capable of moving along a guiding structure.

FIG. 5C show a cross-sectional view of another sleeve.

FIG. 6 shows a universal joint.

FIG. 7 is a flow chart illustrating a process that may be used to adjust the viewing angle the second mounting structure.

FIG. 8 shows possible paths that may be taken to move the second mounting structure from a first position to a second position.

FIG. 9 shows the second mounting structure of FIG. 1 in a second position.

FIG. 10 shows the mounting system of FIG. 1 capable of adjusting the viewing angle of the second mounting structure in the negative X direction relative to the first mounting structure.

FIG. 11 shows the mounting system of FIG. 1 capable of adjusting the viewing angle of the second mounting structure in the positive Y direction relative to the first mounting structure.

FIG. 12 shows defining the second position of the second mounting structure as in the negative Y direction relative to the first mounting structure.

FIG. 13 shows the mounting system of FIG. 1 tilting the second mounting structure in a desired direction.

FIG. 14 shows the mounting system of FIG. 1 tilting the second mounting structure in a different orientation.

FIG. 15 shows the mounting system of FIG. 1 tilting the second mounting structure in another orientation.

FIG. 16 shows that the second mounting structure tilted in yet another orientation.

FIG. 17 shows the mounting system capable of tilting the second mounting structure in still another orientation.

FIG. 18 shows the mounting system tilting the second mounting structure in a different orientation.

FIG. 19 shows the mounting system mounted in an inverted direction as compared the orientation shown in FIG. 1.

FIG. 20 shows a perspective view of another mounting system.

FIG. 21 shows a front of the first mounting structure of FIG. 20.

FIG. 22 shows that the mounting system of FIG. 20 is capable of tilting the second mounting structure.

FIG. 23 shows a first mounting structure of yet another mounting system.

FIG. 24 shows a first mounting structure of still another mounting system.

FIG. 25 shows a perspective view of another mounting system.

FIG. 26 shows a processor linked to a motor to adjust the angle θ₃.

FIG. 27 shows a manual mounting system.

FIGS. 28A and 28B show cross-sectional views of a sleeve that may be operated manually to move along a guiding structure.

FIG. 29 shows a mounting system with a fourth set of sleeves adapted to move along a fourth guiding structure.

FIG. 30A shows a mounting system with an elongated guiding structure along the X-axis and two guiding structures along the Y-axis.

FIG. 30B shows the two vertical screws closer together as compared to FIG. 30A.

FIG. 31 shows alternative methods to provide input signals to the processor to adjust the viewing angle of the second mounting structure.

FIG. 32 shows the second mounting structure tilted counter-clockwise direction in reference to XY plane.

FIG. 33 shows a perspective view of another mounting system.

FIG. 34 shows a more detail view of the beams shown in FIG. 33.

FIG. 35 is a cross-sectional view of the pivot point along the line 35-35 in FIG. 34.

FIG. 36 is a perspective view of the bracket.

FIGS. 37A, 37B, and 37C show a first set of beams extending from a first position, as shown in FIG. 37A, to an intermediate position, as shown in FIG. 37B, then to a second position, as shown in FIG. 37C.

FIG. 38A shows tilting a monitor in the clockwise direction along the XZ.

FIG. 38B shows moving a monitor laterally in the positive X direction.

FIG. 38C shows a monitor tilted in the counter-clockwise direction along the YZ plane.

FIG. 39 shows an alternative way of moving a sleeve along a screw.

### DETAIL DESCRIPTION OF THE INVENTION

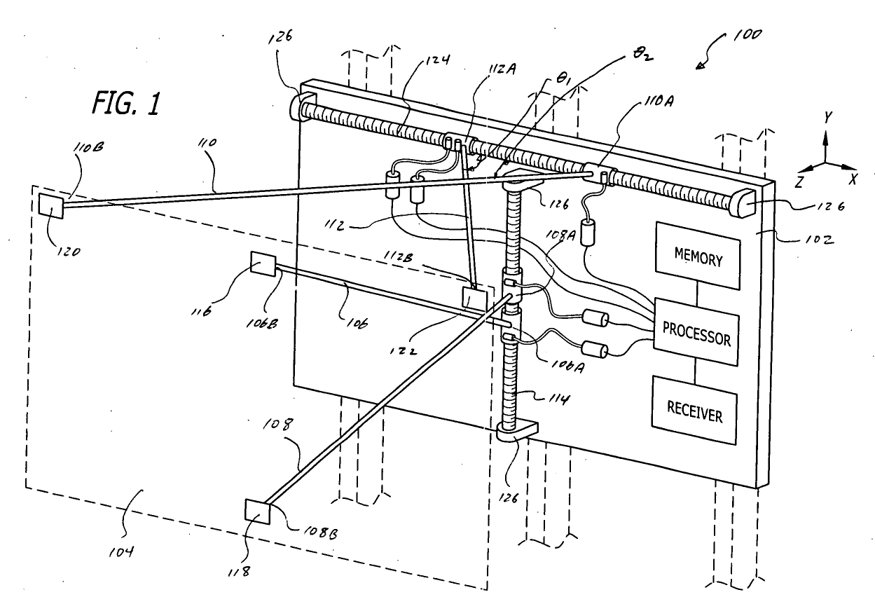

FIG. 1 shows a perspective view of a mounting system 100 capable of adjustably mounting a second mounting structure 104 to a first mounting structure 102 with reference to X, Y, and Z axes. In this example, the direction in the negative Y-axis may generally represent the gravitational force. The mounting system 100 may have a first set of beams 106 and 108, and a second set of beams 110 and 112. The beam 106 has a first end 106A and a second end 106B, where the first end 106A may slide along a guiding structure 114 juxtaposed to the first mounting structure 102 substantially in the Y-axis. The second end 106B of the beam 106 may be pivotally coupled to the second mounting structure 104 at a location 116 of the second mounting structure 104. The beam 108 has a first end 108A and a second end 108B, where the first end 108A may slide along the guiding structure 114. The second end 108B of the beam 108 may be pivotally coupled to the second mounting structure 104 at a location 118 of the second mounting structure 104. In general, a line drawn between the two locations 116 and 118 may be substantially in the Y-axis and about the center of the second mounting structure 104. The two beams 106 and 108 may couple the second mounting structure 104 to the first mounting structure 102 in a diagonal manner such that the two beams 106 and 108 cross each other. As such, the second end 106B is in the positive Y position relative to the second end 108B, but the first end 108A is in the positive Y position relative to the first end 106A.

The beam 110 has a first end 110A and a second end 110B, where the first end 110A may slide along the guiding structure 124 juxtaposed to the first mounting structure 102 substantially in the X-axis. The second end 110B of the beam 110 may be pivotally coupled to the second mounting structure 104 at a location 120 of the second mounting structure 104. The beam 112 has a first end 112A and a second end 112B, where the first end 112A may slide along the guiding structure 124. The second end 112B of the beam 112 may be pivotally coupled to the second mounting structure 104 at a location 122 of the second mounting structure 104. In this example, the location 120 may be in the upper-left corner of the second mounting structure 104, and the location 122 may be in the upper-right corner of the second mounting structure 104. In general, a line drawn between the two locations 120 and 122 may be in the X-axis. The two beams 110 and 112 may couple the second mounting structure 104 to the first mounting structure 102 in a diagonal manner such that the two beams 110 and 112 cross each other. Note that if the beam 108 crosses the beam 106 so that the beam 108 is on the positive side along the X-axis of the beam 106, then the beam 110 may be placed on the positive side along the Y-axis of the beam 112. Arranging the first set of beams 106 and 108, and the second set of beams 110 and 112 in the manner as described above or vice versa may substantially prevent the second mounting structure 104 from leaning towards one direction. The guiding structure 114 may be substantially perpendicular to the guiding structure 124. In this example, the two guiding structures 114 and 124 may generally form a “T” shape configuration.

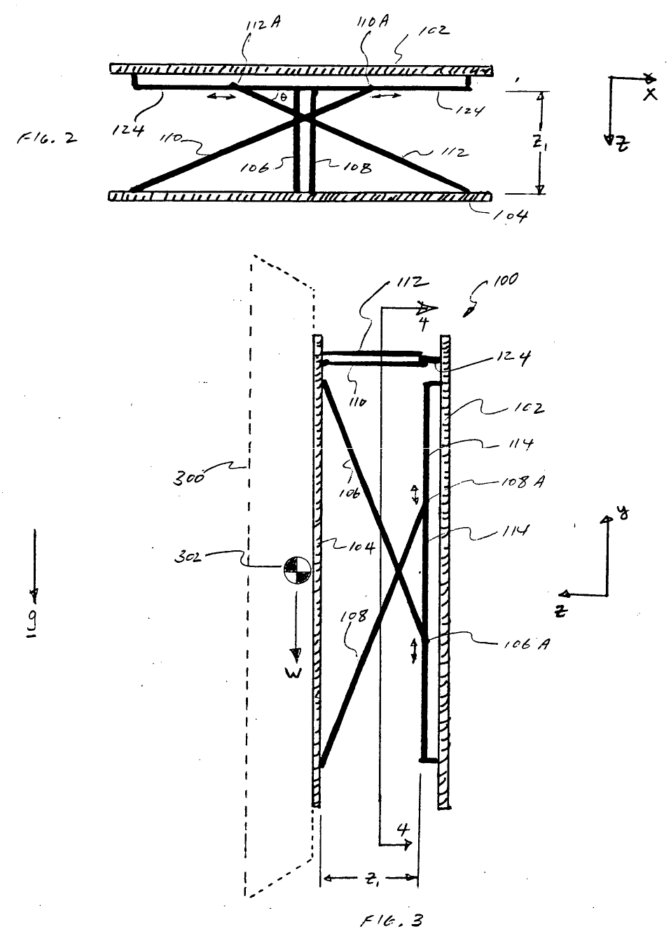

FIGS. 2 and 3 are two views of the mounting system 100 in the XZ plane and YZ plane, respectively. FIGS. 1, 2, and 3 show the second mounting structure 104 extended along the positive Z-axis relative to the first mounting structure 102. The second mounting structure 104 may be further extended from the first mounting structure 102 by sliding the two first ends 106A and 108A closer together along the guiding structure 114 and sliding the two first ends 110A and 112A closer together along the guiding structure 124, and allowing the second ends 106B, 108B, 110B, and 112B to pivot about their respective locations 116, 118, 120, and 122 on the second mounting structure 104. The pair of first ends 106A and 108A may be moved closer together symmetrically, and the pair of first ends 110A and 112A may be moved closer together symmetrically so that the second mounting structure 104 may move in the positive Z-axis while being substantially parallel with the first mounting structure 102. The second ends 106B, 108B, 110B, and 112B may be pivotally coupled to the second mounting structure 104 through a universal joint to allow the ends 106B, 108B, 110B, and 112B to pivot freely about their respective locations 116, 118, 120, and 122 on the second mounting structure 104. Alternatively, the second ends of the beams may be pivotally coupled to the second mounting structure 104 with ball joints. In other words, each of the second ends 106B, 108B, 110B, and 112B may be provided with a ball end and each of their respective locations 116, 118, 120, and 122 on the second mounting structure 104 may be provided with a concave socket adapted to receive the ball end so that the second ends may pivot about the their respective locations.

The second mounting structure 104 may be moved in the negative Z-axis or closer to the first mounting structure 102 by sliding the pair of two first ends 106A and 108A, and the pair of first two ends 110A and 112A away from each other along the guiding structures 114 and 124, respectively. For instance, the pair of first two ends 106A and 108A may be spaced apart as much as possible along the guiding structure 114, and the pair of first two ends 110A and 112A may be spaced apart as far as possible along the guiding structure 124 as well to substantially flush the second mounting structure 104 against the first mounting structure 102. In addition, by fixing the first ends 106A and 108A along the guiding structure 114, the first ends 110A and 112A along the guiding structure 124, and the angle θ₁ between the guiding structure 124 and the beam 112 or the angle θ₂ between the guiding structure 124 and the beam 110, the orientation of the second mounting structure 104 relative to the first mounting structure 102 may be adjusted in a variety of ways and held in the desired position.

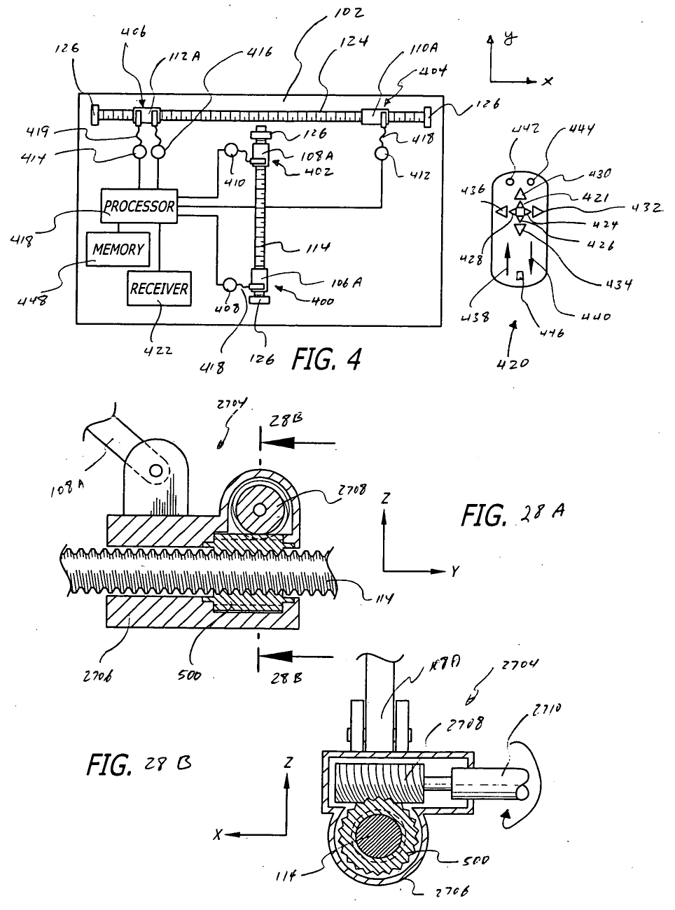

FIG. 4 is a front view of the first mounting structure 102 illustrating that a motor may be coupled to at least one of the first ends 106A, 108A, 110A, and 112A to move that first end remotely. In this example, the guiding structure 114 may be tangential or perpendicular to the guiding structure 124. The first ends 106A and 108A may be coupled to their respective sleeves 400 and 402, and the first ends 110A and 112A may be coupled to their respective sleeves 404 and 406. The sleeves 400 and 402 are adapted to slide along the guiding structure 114 or generally along the Y-axis, and sleeves 404 and 406 are adapted to slide along the guiding structure 124 or generally along the X-axis. In this example, each sleeve may be coupled to an electric motor to move each of the sleeves independently along its respective guiding structure, i.e. the guiding structure 114 or 124. For instance, motors 408, 410, 412, and 414 may be coupled to the sleeves 400, 402, 404, and 406, respectively. In addition, the sleeve 406 may be provided with a second motor 416 to adjust the angle θ₁ as explained in further detail below.

The motors may be linked to a processor 418 that controls the rotation of the motors based on the input signal provided by the remote control 420. The remote control 420 may be provided with a number of buttons to control one or more the motors. The remote control 420 may send input signals to a receiver 422 which then passes the input signals to the processor 418 to process signal to control the motors. Depending on the rotational direction of the motor, the sleeve may move either in the positive or negative direction of its guiding structure, which in turn adjusts the orientation of the second mounting structure 104 relative to the first mounting structure 102. The motors may be directly coupled to their respective sleeves to provide power to the gear. Alternatively, a transfer line 419 may be provided between the motor and the corresponding sleeve to transfer the rotational force of the motor to the gear in the sleeve. This way the motors may be attached to the first mounting structure 102 and the sleeves may freely move along their respective guiding structure.

The remote control 420 may be provided with the following control buttons to adjust the viewing angle of the second mounting structure 104: buttons 421, 424, 426, and 428 to move the second mounting structure 104 laterally in the positive Y-axis, positive X-axis, negative Y-axis, axis, and negative X-axis, respectively; buttons 430, 432, 434, and 436 to tilt the second mounting structure 104 in the clockwise direction along the YZ plane which may be considered as the first plane, counter-clockwise direction along the XZ plane which may be considered as the second plane, counter-clockwise direction in the YZ plane, and clockwise direction in the XZ plane, respectively; a button 438 to move the second mounting structure 104 in the positive Z-axis or extend the second mounting structure 104 from the first mounting structure 102; a button 440 to move the second mounting structure in the negative Z-axis or retract the second mounting structure 104 to the first mounting structure 102; a button 442 to turn on the mounting system 100; and a button 444 to turn off the mounting system 100. Activating the buttons provided with the remote control 420 may send a corresponding input signal number to the receiver 422 which is then passed on to the processor 418 to execute the command from the remote control 420. For example, if a user activates the button 432, then the remote control 420 may send an input signal 432 to the receiver 422, or if the button 428 is activated, then the remote control may send an input signal 428 to the receiver 422.

The processor 418 may be also linked to a memory 448, where a predetermined desired viewing angle may be stored. The remote control 420 may also have a preset button 446 that provides an input signal 446 to the processor 418 to adjust the viewing angle of the second mounting structure 104 to the desired stored viewing angle. For example, a user may adjust the viewing angle of the second mounting structure 104 to a desired position. A user may then activate the preset button 446 to associate the preset button 446 to the desired viewing angle of the second mounting structure 104 and the desired angle may be stored in the memory 448. Once the preset button 446 has been programmed, subsequent activation of the preset button 446 indicates to the processor 418 to adjust the viewing angle of the second mounting structure 104 to the desired viewing angle stored in the memory 448. Note that the input signals to the processor 418 may be provided in a variety of ways such as through the Internet, hard wire, computer network, and the like. In addition, the remote control 420 may have a memory to store the desired viewing angle.

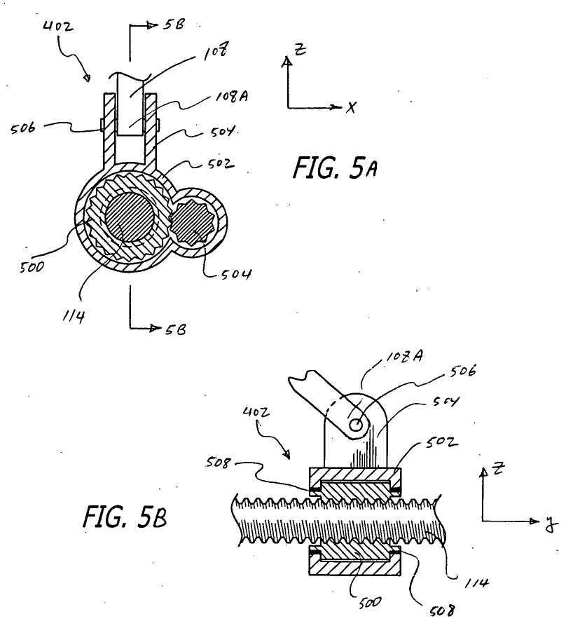

FIGS. 5A and 5B show cross-sectional views of the sleeve 402 capable of moving along the guiding structure 114 at a predetermined increment. In this example, the guiding structure 114 may be represented as a screw. As shown in FIGS. 1 and 4, the screw 114 may be coupled to the first mounting structure 102 with end caps 126 such that the screw 114 is substantially prevented from spinning. The sleeve 402 includes a nut 500 within a housing 502. The nut 500 may spin or rotate relative to the screw 114 to cause the sleeve 402 to move along the Y-axis. The spinning direction of the nut 500, either in the clockwise or counter-clockwise direction around the screw 114, causes the sleeve 402 to move either in the positive or negative direction along the Y-axis. A number of spins or a portion of a spin of the nut 500 may correspond to a distance the sleeve travels along the Y-axis. As illustrated in FIG. 5B, bearings 508 may be provided between the nut 500 and the housing 502 to minimize friction between the two.

The housing 502 of the sleeve 402 may have a flange 504 adapted to couple the first end 108A of the beam 108 about the pivot point 506 to allow the beam 108 to pivot about the pivot point 506. The motor 412 corresponding to the sleeve 402 may be coupled to a gear 504 to cause the nut 500 to rotate around the screw 114. The processor may control the power provided to the motor 412 to cause the gear 504 to turn either in the clockwise or counterclockwise direction to move the sleeve 402 in the positive or negative direction along the screw 114. When the motor 412 is not energized, the sleeve 402 may be substantially prevented from moving along the Y-axis of the screw 114, but the sleeve 402 may be allowed to spin or rotate around the screw 114 or the Y-axis. Sensors may be provided along the screw 114 to determine the location of the sleeve 402 along the longitudinal axis of the screw 114. Alternatively, a number of revolutions or turn of the coil in the motor 412 or nut 500 may be monitored to generally estimate the location of the sleeve 402 on the screw 114. The sleeves 400, 404 and 406 may be similar to the sleeve 402 illustrated above.

FIG. 5C show a cross-sectional view of the sleeve 406 capable of moving along the X-axis and pivot the beam 112 at a desired angle θ₃. The sleeve 406 includes a nut 500 within a housing 510. The nut 500 may spin or rotate relative to the screw 124 which represents the guiding structure 124 shown in FIG. 4. The sleeve 406 may include a worm gear 512 that is engaged with the nut 500. The worm gear 512 is coupled to the motor 414 such that rotation of the worm gear 512 causes the nut 500 to turn, thereby causing the sleeve 406 to move along a longitudinal axis of the screw 124 in the desired direction. The housing 510 may also be provided with a first gear 514 and a second gear 516. The first gear 514 may be coupled to the first end 112A of the beam 112 to allow the beam 112 to pivot about a pivot axis 518. The first gear 514 may be smaller than the second gear 516 to provide a predetermined gear ratio adapted to pivot the beam 112 about the pivot axis 518. The second gear 516 may be coupled to the motor 416 (shown in FIG. 4) so that as the motor 416 spins the second gear 516, the first gear 514 spins in the opposite direction of the second gear 516; thereby adjusting the angle θ₃ between the screw 124 and the longitudinal axis of the beam 112. Note that one or both of the sleeves 404 and 406 may be provided with first and second gears 516 and 518 to adjust the angle between the screw 124 and the beam 110 and/or 112.

Referring back to FIGS. 5A and 5B, a motor may be directly coupled to the nut 500 and enclosed within the housing 502, thereby eliminating the need for transfer lines 419. As such, the motors would move axially along the guiding structures.

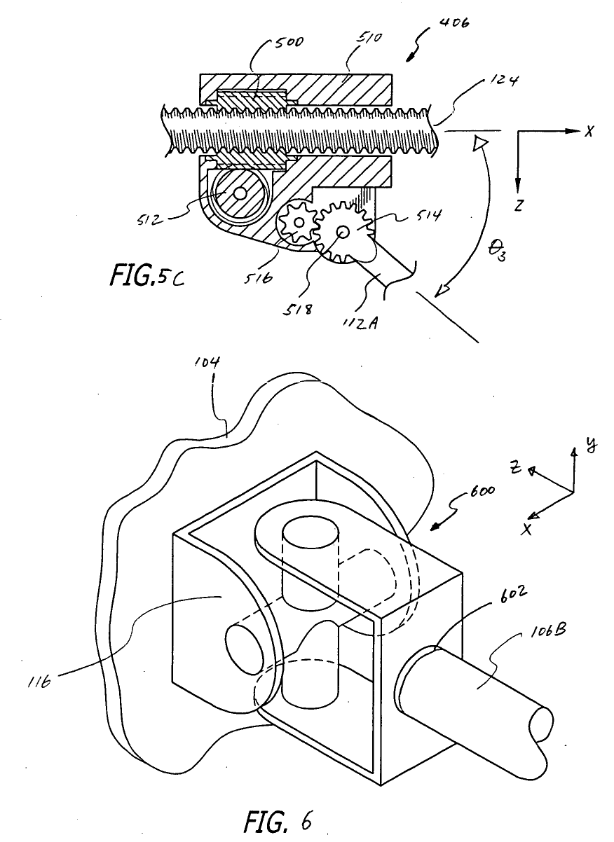

FIG. 6 shows a universal joint 600 adapted to pivotally couple the second end 106B of the beam 106 to the second mounting structure 104. The universal joint 600 may be coupled at the location 116 of the second mounting plate 104. The universal joint 600 allows the second end 106B to pivot in many directions at the location 116 of the second mounting structure 104. Likewise, the universal joints 600 may be used to pivotally couple the second ends 108B, 110B, and 112B to the second mounting structure 104 at their respective locations.

Based on the input signal(s) from the remote control 420, the processor 418 may control the location of the sleeves 400 and 402 along the screw 114, the location of the sleeves 404 and 406 along the screw 124, and the angle θ₃ between the guiding structure 124 and the longitudinal axis of the beam 112. Adjusting the locations of the sleeves and the angle θ₃, in turn adjusts the viewing angle of the second mounting structure 104. Once the viewing angle of the second mounting structure 104 has been adjusted, the processor 418 may turn off the power to the motors 408 through 416, thereby substantially fixing the location of the sleeves and angle θ₃ such that the viewing angle of the second mounting structure 104 is substantially held in the desired orientation.

When the viewing angle of the second mounting structure 104 is fixed, the weight of the monitor coupled to the second mounting structure 104 is substantially carried by the beams 106 through 112 as a compression or tension load. As beams are better able to carry compression and tension loads versus bending loads, the mounting system 100 is able to carry more weight. For instance, referring back to FIG. 4, the center of gravity of a monitor 300 attached to the second mounting structure 104 may be at location 302. The combined weight “W” of the monitor 300 and the mounting system 100 is transferred to first mounting structure 102 through the beams 106 through 112. In this example, the beams 108, 110, and 112 will be generally under tension load, while the beam 106 will be generally under compression load. That is, with the beams having pivotable ends, there are minimal, if any, bending loads on the beams. This allows the mounting system 100 to move further away from the first mounting structure 102 along the Z-axis without overstressing the beams.

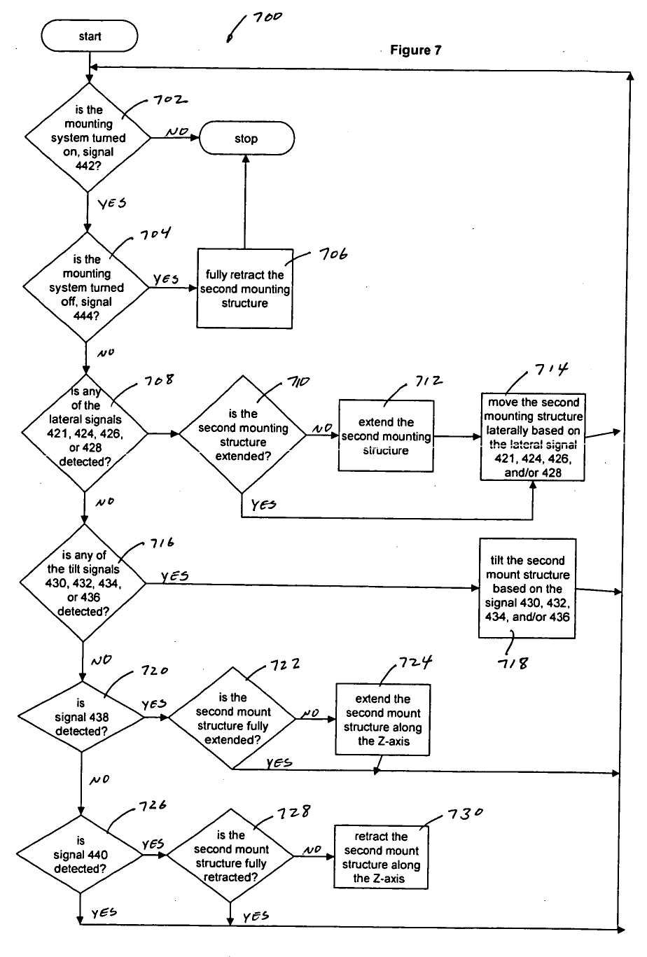

FIG. 7 shows a flow chart 700 illustrating a process that may be used to adjust the viewing angle of the second mounting structure 104. The process illustrated in the flow chart 700 may be followed by the processor 418 to control the motors to adjust the viewing angle of the second mounting structure 104 in relation to the first mounting structure 102. In decision block 702, the processor 418 may monitor whether the mounting system 100 is turned ON by a user if the on signal 442 is sent from the remote control 420. In decision block 704, once the processor 418 detects the on signal 422, the processor 418 may then detect for the off signal 444 from the remote control 420. If the off signal 444 is detected, then in block 706, the processor 418 may fully retract the second mounting structure 104 so that it is substantially flush with the first mounting structure 102. Once the second mounting structure 104 is retracted, the mounting system 100 may be turned off. In decision block 708, if the processor 418 detects any of the lateral signals 422, 424, 426, and 428 from the remote control 420, then in the decision block 710, the processor may determine if the second mounting structure 104 is extended from the first mounting structure 102 along the Z-axis or not. If the second mounting structure 104 is substantially flush against the first mounting structure 102, then in block 712, the processor may extend the second mounting structure 104 from the first mounting structure 102 along the Z-axis to allow the second mounting structure 104 to move laterally substantially along the XY plane. That is, the second mounting structure 104 may not be able to move laterally along the XY plane unless the second mounting structure 104 is extended from the first mounting structure 102 to allow the beams 106 and 108 to pivot about the guiding structure 114.

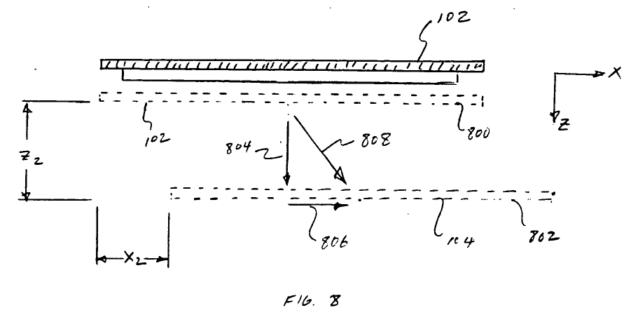

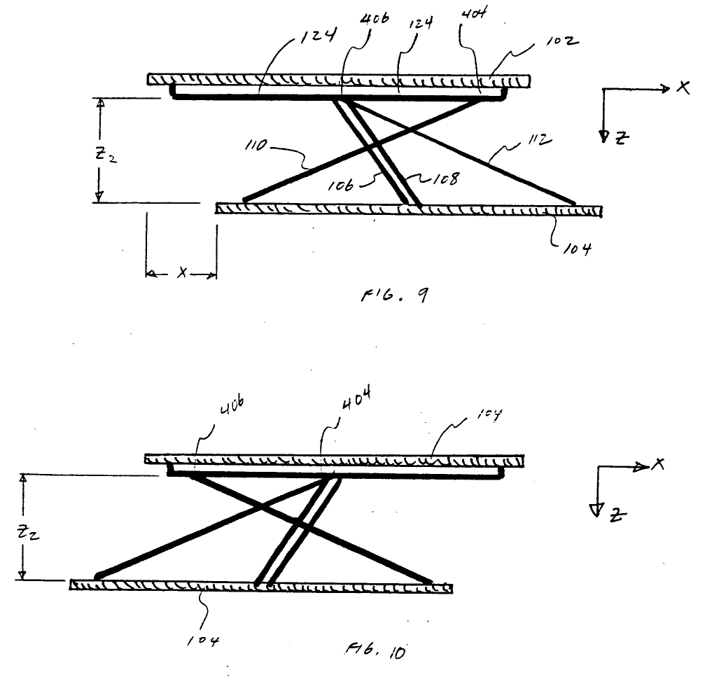

In reference to block 712, FIG. 8 shows possible paths that may be taken to move the second mounting structure 104 from a first position 800 to a second position 802. In the first position 800, the second mounting structure 104 is substantially flush against the first mounting structure 102. In the second position 802, the second mounting structure 104 is at a positive distance Z₂ along the Z-axis and a positive distance X₂ along the X-axis relative to the first position 800. One way to move the second mounting structure 104 from the first position 800 to the second position 802 is to take two steps: as noted in the block 712, the second mounting structure 104 may be moved in the positive Z-axis by a distance Z₂ as indicated by the direction arrow 804. FIG. 2 shows moving the second mounting structure 104 in the positive Z-axis. Once the second mounting structure 104 has been extended in the Z-axis as noted in the block 712, then in the block 714, the processor 418 may move the second mounting structure 104 in the positive X-axis by a distance X₂ along the XY plane as indicated by the direction arrow 80 to the second position. FIG. 9 shows the second mounting structure 104 in the second position.

Alternatively, the steps taken in blocks 712 and 714 may be done in one step by moving the second mounting structure 104 from the first position to the second position diagonally as indicated by the direction arrow 808 in FIG. 8. In this example, the processor 418 may provide power to the motors 408 and 410 to move the sleeves 400 and 402 closer together thereby extending the second mounting structure 104 along the positive Z-axis, and simultaneously provide power to the motor 414 to move the sleeve 406 to the positive X-axis direction and to the motor 416 to adjust the angle θ₃ so that the second mounting structure 104 may move diagonally and substantially parallel relative to the first mounting structure 102.

In the decision block 710, if the second mounting structure 104 is extended from the first mounting structure 102 along the Z-axis, then in block 714, the processor 418 may control the motors to move the second mounting structure 104 laterally in the positive Y-axis, positive X-axis, negative Y-axis, and negative X-axis relative to the first mounting structure 102 in the XY plane based on any one or more of the lateral signals 422, 424, 426, and 428, respectively, received from the remote control 420. For instance, FIG. 2 may represent the second mounting structure 104 in a first position where the second mounting structure 104 is extended by a distance Z₁ from the first mounting structure 102 along the Z-axis. In block 714, if the remote control 420 sends the lateral signal 424 to move the second mounting structure 104 laterally in the positive X-axis, the processor 418 may control the motors to move the second mounting structure 104 from the first position, as shown in FIG. 2, to a second position, as shown in FIG. 9, where the second mounting structure 104 is extended by a distance Z₂ from the first mounting structure 102 along the Z-axis and moved laterally along the positive X-axis or to the right side of the first mounting structure 102.

The second mounting structure 104 may be moved from the first position to the second position by moving the sleeves 404 and 406 to the positive X direction while maintaining the same distance between the sleeves 404 and 406. The processor 418 may move the sleeves 404 and 406 to the positive X direction along the guiding structure 124 independently but may maintain a substantially same distance between the two sleeves 404 and 406 so that the distance between the two sleeves 404 and 406 is about the same in the first and second positions. By substantially maintaining a constant distance between the two sleeves 404 and 406, the second mounting structure 104 may move from the first position to the second position in a substantially lateral manner relative to the first mounting structure 102. In other words, the second mounting structure 104 moves from the first position to the second position in a substantially parallel manner relative to the first mounting structure 102. Note that as the sleeves 404 and 406 move in the positive X direction, the sleeves 410 and 408, although not energized by the processor 418, rotate around the guiding structure 114 to allow the second mounting structure 104 to move from the first position to the second position. In this example, if the processor does not provide power to the two sleeves 400 and 402 so that they do not move in the Y-axis along the guiding structure 114, then Z₂<Z₁. Alternatively, the processor 418 may provide power to the two sleeves 400 and 402 to move the two sleeves closer together to extend the second mounting structure in the positive Z axis so that Z₂ may be substantially equal to Z₁. For instance, the processor may provide power to the motors 408 and 410 to move the sleeve 400 in the positive Y-axis and move the sleeve 402 in the negative Y-axis, respectively.

In block 714, if the remote control 420 sends the lateral signal 428 to move the second mounting structure 104 laterally in the negative X-axis, FIG. 10 shows the mounting system 100 capable of adjusting the viewing angle of the second mounting structure 104 in the negative X direction relative to the first mounting structure 102. In this example, FIG. 10 shows the second mounting structure 104 in the second position. The processor 418 may provide power to the motors 412 and 414 to move the sleeves 404 and 406, respectively, along the guiding structure 124 in the negative X-axis direction to move the second mounting structure 104 to the second position.

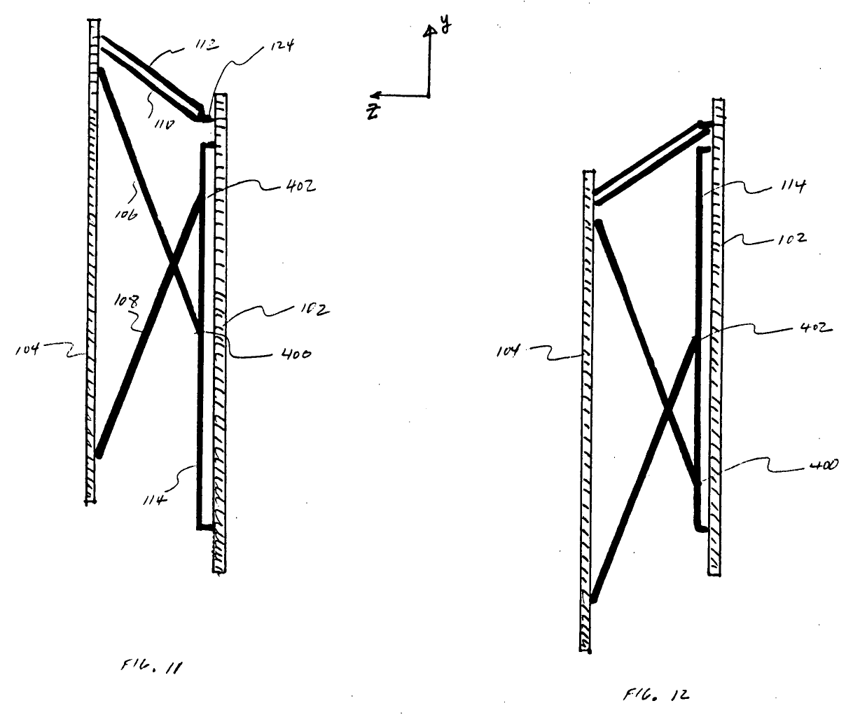

In block 714, if the remote control 418 sends the lateral signal 424 to move the second mounting structure 104 laterally in the positive Y-axis, FIG. 11 shows the mounting system 100 capable of adjusting the viewing angle of the second mounting structure 104 in the positive Y direction relative to the first mounting structure 102. In this example, FIG. 3 may represent a first position of the second mounting structure 104 relative to the first mounting structure 102, and FIG. 11 may represent a second position of the second mounting structure 104 relative to the first mounting structure 102. To move the second mounting structure 104 from the first position to the second position, the processor 418 may provide power to the motors 408 and 410 to move the sleeves 400 and 402, respectively, in the positive Y direction. The processor 418 may move the sleeves 400 and 402 to the positive Y direction along the guiding structure 114 independently but may maintain a substantially same distance between the two sleeves 404 and 406 to move the second mounting structure 104 in a substantially lateral manner relative to the first mounting structure 102. In other words, the second mounting structure 104 moves from the first position to the second position in a substantially parallel manner relative to the first mounting structure 102. As the sleeves 400 and 402 are moved in the positive Y direction, the beams 110 and 112 may pivot around the guiding structure 124. Conversely, FIG. 12 shows defining the second position of the second mounting structure 104 as in the negative Y direction relative to the first mounting structure 102. In this example, the processor 418 may provide power to the motors 408 and 410 to move the sleeves 400 and 402, respectively in the negative Y-direction along the guiding structure 114.

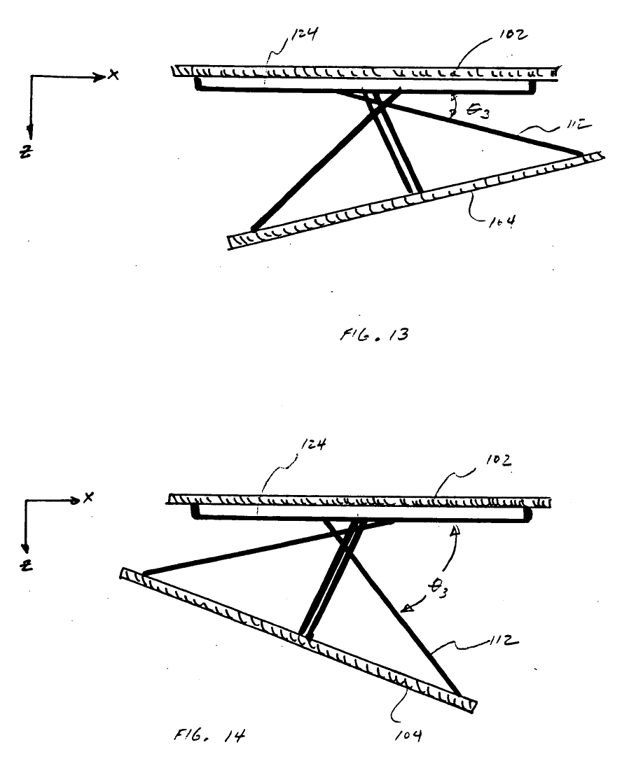

In decision block 716, if the processor 418 detects any of the tilt signals 430, 432, 434, and 436 from the remote control 420, then in block 718, the processor may tilt the second mounting structure in accordance with the input signal from the remote control 420. In block 718, if the remote control sends the tilt signal 432 to tilt the second mounting structure 104 in a counter-clockwise direction in the XZ plane or along the second plane, FIG. 13 shows the mounting system 100 capable of tilting the second mounting structure 104 in accordance with the tilt signal 432. In this example, FIG. 2 may represent a first position of the second mounting structure 104 relative to the first mounting structure 102, and FIG. 13 may represent a second position of the second mounting structure 104 relative to the first mounting structure 102. As discussed in reference to FIG. 5C, the processor 418 may provide power to the motor 416 to reduce the angle θ₃ between the beam 112 and the guiding structure 124 thereby tilting the second mounting structure 104 in the counter-clockwise direction from the first position to the second position. Note that as the angle θ₃ is adjusted, the sleeves 410 and 408, although not energized by the processor 418, rotate around the guiding structure 114 to allow the second mounting structure 104 to move from the first position to the second position.

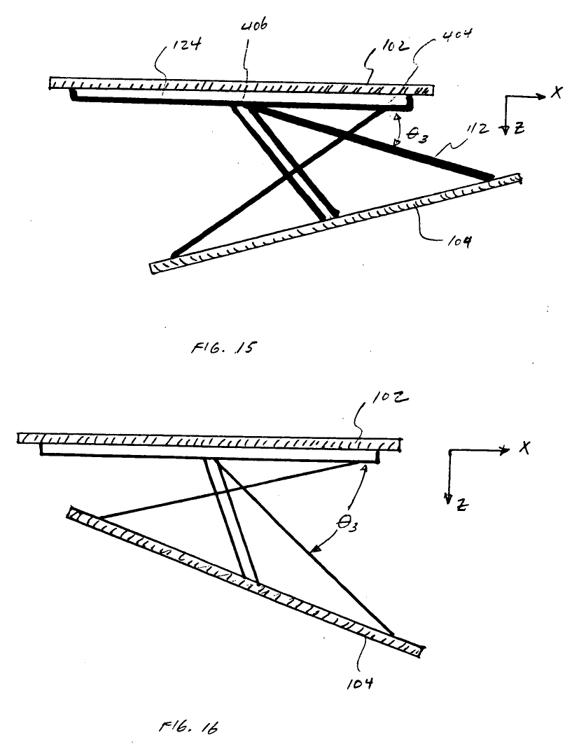

In the block 718, if the remote control 420 sends the tilt signal 436 to tilt the second mounting structure 104 in a clockwise direction in the XZ plane or along the second plane, FIG. 14 shows the mounting system 100 capable of tilting the second mounting structure 104 in accordance with the tilt signal 436. In this example, FIG. 2 may represent the second mounting structure in a first position relative to the first mounting structure 102, and FIG. 14 may represent the first plat 102 in a second position relative to the first mounting structure 102. The processor 418 may tilt the second mounting structure 104 in the clockwise direction in the XZ plane by providing power to the motor 416 to increase the angle θ₃. This in turn tilts the second mounting structure 104 to the second position.

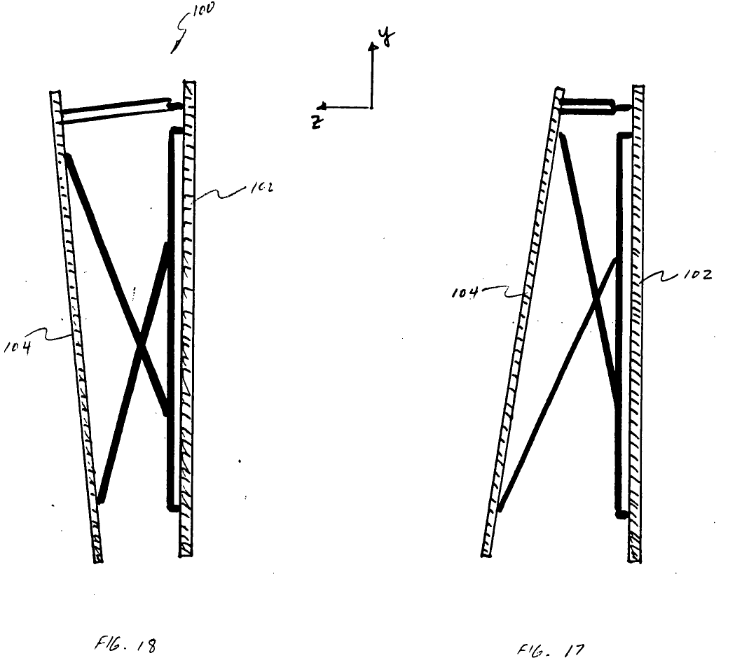

In the block 718, the mounting system 100 may tilt the second mounting structure 104 when the second mounting structure 104 is at the positive X-axis or to the right side of the first mounting structure 102. In this example, FIG. 9 may represent the second mounting structure in a first position, and FIG. 15 may represent the second mounting structure 104 in a second position. As discussed in reference to FIG. 5C, the processor 418 may provide power to the motor 416 to reduce the angle θ₃ between the beam 112 and the guiding structure 124 thereby tilting the second mounting structure 104 in the counter-clockwise direction in the XZ plane or along the second plane. As such, the processor 418 may control the motor 416 to tilt the second mounting structure from the first position to the second position. Conversely, FIG. 16 shows that the second mounting structure 104 may be tilted in the clockwise direction in the XZ plane.

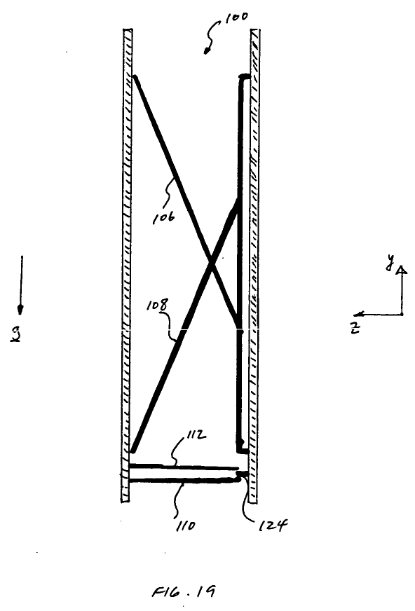

In the block 718, if the remote control sends the tilt signal 430 to tilt the second mounting structure 104 in a clockwise direction in the YZ plane or along the first plane, FIG. 17 shows that the mounting system 100 is capable of tilting the second mounting structure 104 in accordance with the tilt signal 430. In this example, FIG. 3 may represent the second mounting structure 104 in the first position relative to the first mounting structure 102, and FIG. 17 may represent the first plat 102 in the second position. The processor 418 may tilt the second mounting structure 104 from the first position to the second position through a number of ways, such as: (1) providing power to the motor 408 to move the sleeve 400 along the guiding structure 114 while not providing power to the motors corresponding to the other sleeves 402, 404, and 406 to hold the other sleeves in their place; (2) providing power to the motor 410 to move the sleeve 402 along the guiding structure 114 while not providing power to the motors corresponding to the sleeves 400, 404, and 406 to hold these sleeves in their place; (3) providing power to the motors 408 and 410 to move the sleeves 400 and 402 while not providing power to the motors corresponding to the two sleeves 404 and 406; or (4) providing power to the motors 412 and 414 to move the two corresponding sleeves 404 and 406 while not providing power to the motors corresponding to the sleeves 400 and 402. For instance, with the option (1), the second mounting structure 104 may tilt in the counter-clockwise direction in the YZ plane or along the first plane, if the sleeve 400 is moved in the negative Y direction along the guiding structure 114; conversely, the second mounting structure 104 may tilt in the clockwise direction if the sleeve 400 is moved in the positive Y direction. Likewise, with the option (2), the second mounting structure 104 may tilt in the counter-clockwise direction if the sleeve 402 is moved in the negative Y direction along the guiding structure 114; conversely, the second mounting structure 104 may tilt in the clockwise direction if the sleeve 402 is moved in the positive Y direction. With the option (3), the two sleeves 400 and 402 may be moved away from each other to tilt the second mounting structure 104 in the counter-clockwise direction; and conversely, the two sleeves 400 and 402 may be moved closer together to tilt the second mounting structure 104 in the clockwise direction. With the option (4), the two sleeves 404 and 406 may be moved away from each other to tilt the second mounting structure 104 in the counter-clockwise direction; and conversely the two sleeves 404 and 406 may be moved closer together to tilt the second mounting structure 104 in the clockwise direction.

In the block 718, if the remote control sends the tilt signal 434 to tilt the second mounting structure 120 in a counter-clockwise direction in the YZ plane or along the first plane, FIG. 18 shows that the mounting system 100 is capable of tilting the second mounting structure 104 in accordance with the tilt signal 434 in many ways as discussed above in reference to FIG. 17. As such, the mounting system 100 may perform like a universal joint to allow the second mounting structure 104 to be adjusted in a number of ways relative to the first mounting structure 102.

In the decision block 720, if the processor 418 detects the extension signal 438, then in the decision block 722, the processor may determine if the second mounting structure 104 is already fully extended or not. In the block 724, if the second mounting structure 104 is not fully extended, then the processor may extend the second mounting plate 104 by moving the sleeves closer together along their respective screws. Conversely, in the decision block 726, if the processor 418 detects the retraction signal 440, then in the decision block 728, the processor may determine if the second mounting structure 104 is already fully retracted or not. In the block 730, if the second mounting structure 104 is not fully retracted, then the processor may retract the second mounting plate 104 by moving the sleeves away from each other along their respective screws

FIG. 19 shows that the mounting system 100 may mounted in an inverted direction as shown in FIG. 1, where the beams 110 and 112 are located below the beams 106 and 108. In this embodiment, the mounting system 100 may adjust the viewing angle of the second mounting structure 104 in a substantially similar manner as discussed above.

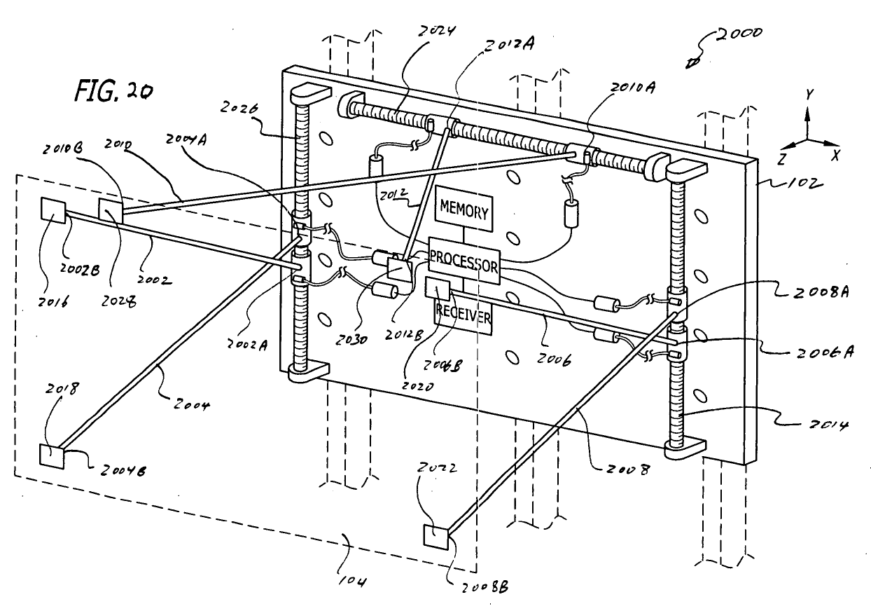

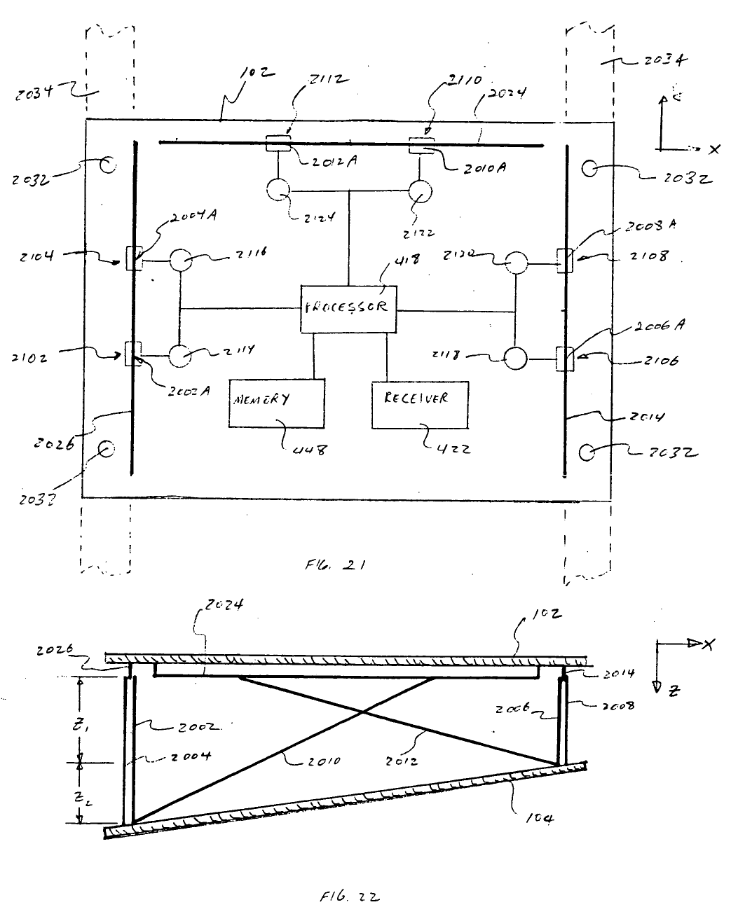

FIG. 20 shows a perspective view of a mounting system 2000 capable of adjustably mounting a second mounting structure 104 to a first mounting structure 102 with reference to X, Y, and Z axes, where the negative Y-axis generally represents the direction of the gravitational force. The mounting system 2000 includes a first set of beams 2002 and 2004, a second set of beams 2006 and 2008, and a third set of beams 2010 and 2012. Similar to the mounting system 100, each beam has two ends where the first end may slide along a guiding structure juxtaposed to the mounting structure 102 and the second end may be pivotally coupled to the second mounting structure 104. For instance, the beam 2006 has a first end 2006A and a second end 2006B, where the first end 2006A may slide along the guiding structure 2014 juxtaposed to the first mounting structure 102 substantially in the Y-axis. The second end 2006B of the beam 106 may be pivotally coupled to the second mounting structure 104 at a location 2020 of the second mounting structure 104. As illustrated in FIG. 6, a universal joint 600 may be used to pivotally couple the second end 2006B to the second mounting structure 104 at the location 2020. Likewise, universal joints may be used to pivotally couple the second ends 2002B, 2004B, 2008B, 2010B, and 2012B, at their respective locations 2016, 2018, 2022, 2028, and 2030 on the second mounting structure 104. As such, the first set of beams 2002 and 2004 may slide along the guiding structure 2026 that is substantially in the Y-axis, the second set of beams 2006 and 2008 may slide along the guiding structure 2014 that is substantially in the Y-axis, and the third set of beams 2010 and 2012 may slide along the guiding structure 2024 that is substantially in the X-axis. As shown in FIG. 20, each set of beams may couple the second mounting structure 104 to the first mounting structure 102 in a diagonal manner such that the two beams cross each other.

The distance between the two locations 2016 and 2018 may be substantially equal to the length of the guiding structure 2026, and the distance between the two locations 2020 and 2022 may be substantially similar to the length of the guiding structure 2014. Likewise, the distance between the two locations 2028 and 2030 may be substantially equal to the length of the guiding structure 2024. In addition, the length of the first and second set of beams 2002, 2004, 2006, and 2008 may be substantially equal to the length of the their respective guiding structures 2026 and 2014, and the length of the third set beams 2010 and 2012 may be substantially similar to the length of the guiding structure 2024. With the above configuration, when the second mounting structure 104 is in the retracted position or flush against the first mounting structure 102, the beams may lie substantially parallel with their respective guiding structures to minimize the distance between the first and second mounting structures 102 and 104. In this example, the length of the guiding structure 2024 may be greater than the length of the guiding structures 2014 and 2026. Having a longer guiding structure 2024 allows the second mounting structure to have a greater lateral movement along the X-axis. Alternatively, the distance between the two locations 2028 and 2030 may be less than the length of the line 2024, and the length of the third set of beams 2010 and 2012 may be less than the length of the line 2024 as well. This may allow the second mounting structure 104 to have a greater degree of movement in the X-axis.

FIG. 21 shows a front view of the first mounting structure 102 having sleeves 2102 and 2104 adapted to slide the ends 2002A and 2004A, respectively, along the guiding structure 2026; sleeves 2106 and 2108 adapted to slide the ends 2006A and 2008A, respectively, along the guiding structure 2014; and sleeves 2110 and 2112 adapted to slide the ends 2010A and 2012A, respectively, along the guiding structure 2024. In this example, each sleeve may be coupled to an electric motor to move each of the sleeves independently along its respective guiding structure. For instance, motors 2114, 2116, 2118, 2120, 2122, and 2124 may be coupled to the sleeves 2102, 2104, 2106, 2108, 2110, and 2112, respectively. In this example, the sleeves 2102 through 2112 may be similar to the sleeve shown in FIGS. 5A and 5B. The processor 418 may be linked to the motors to move the sleeves in the desired direction. The processor 418 may control the motors based on input signal provided by the remote control 420, as shown in FIG. 4.

FIG. 21 also shows that the first mounting structure 102 may have a plurality of holes 2032 adapted to receive a bolt. The holes 2032 may be spaced apart along the X-axis to allow the holes 2032 to be aligned with the studs 2034. For instance, the studs 2034 may represent wooden studs within a wall of a home. The mounting system 2000 may be mounted to the wall by inserting a bolt through each of the holes 2032 in the first mounting structure 102 and the wooden studs 2034 in the wall. Once the mounting system 2000 is mounted, a monitor may be attached to the second mounting structure 104 to allow the mounting system 2000 to adjust the viewing angle of the monitor through the remote control 420.

In the mounting system 2000, the processor 418 may follow the steps discussed in the flow chart 700 to process the signal from the remote control 420. The processor 418, however, may execute certain steps in the flow chart 700 differently than the execution steps discussed above in reference to the mounting system 100. For example, in the block 714, the processor 418 may provide power to all of the motors 2102 through 2124 to move each set of motors closer together to extend the second mounting structure 104 in the positive Z-axis. In the block 714, the motors 2114 and 2118 in the mounting system 2000 may correspond to the motor 408 in the mounting system 100 as shown in FIG. 4. Likewise, the motors 2116 and 2120 may correspond to the motor 410, the motor 2122 may correspond to the motor 412, and the motor 2124 may correspond to the motor 214. In the mounting system 2000, the processor 418 may control the corresponding motors, shown in FIG. 21, in substantially the same manner as the motors 400 through 414, shown in FIG. 4, to move the second mounting structure 104 substantially along the XY plane based on the lateral signal 422, 424, 426, and/or 428.

In the block 718, the processor 418 may control the corresponding motors, shown in FIG. 21, substantially the same as the motors 400 through 414, shown in FIG. 4, to tilt the second mounting structure 104 along the XZ plane based on the tilt signal 422 and 434 from the remote control 420 as discussed above in reference to FIGS. 17 and 18, respectively. With regard to tilt signals 432 and 436, the processor 418 may control the motors in the following manner to tilt the second mounting structure 104 in the counter-clockwise and clockwise directions, respectively.

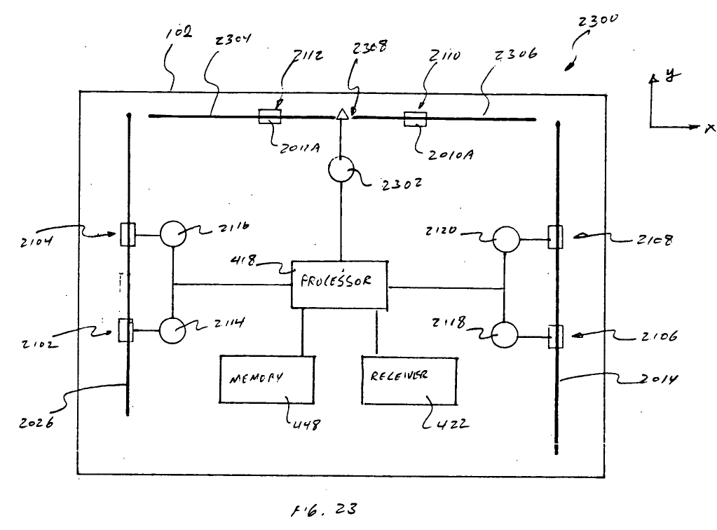

In block 718, if the remote control sends the tilt signal 432 to tilt the second mounting structure 104 in a counter-clockwise direction in the XZ plane, FIG. 22 shows that the mounting system 2000 is capable of tilting the second mounting structure 104 in accordance with the tilt signal 432. In this example, the second mounting structure 104 may be in the first position when the second mounting structure 104 is substantially parallel with the first mounting structure 102 and at a distance Z, from the first mounting structure 102. In the second position, the first set of beams 2002 and 2004 may extend the second mounting structure 104 a distance Z₂ from the first position so that the second mounting structure 104 is tilted in the counter-clockwise direction along the XZ plane. The processor 418 may tilt the second mounting structure 104 from the first position to the second position by providing power to the motors 2114 and 2116 to move the two sleeves 2102 and 2104 closer together, thereby extending the first set of beams 2002 and 204 in the positive Z-axis by a distance Z₂. In addition, the processor 418 may power the motor 2124 to move the sleeve 2112 in the negative X-axis direction along the guiding structure 2024 to allow the second mounting structure 104 to tilt in the counter-clockwise direction in the XZ plane. The processor 418 may not provide power to the motors 2118 and 2120 so that the sleeves 2106 and 2108 substantially remain in their original position along the guiding structure 2014. As such, the second set of beams 2006 and 2008 may maintain the distance Z₁ between the second mounting structure 104 and the first mounting structure 102. With the first set of beams 2002 and 2004 extending further than the second set of beams 2006 and 2008, the second mounting structure 104 may be moved from the first position to the second position.

FIGS. 20 and 21 show the third set of beams 2010 and 2012 of the mounting system 2000 located on the top side of the first set of beams 2002 and 2004, and the second set of beams 2006 and 2008. Alternatively, the third set of beams 2010 and 2012 of the mounting system 2000 may be located at the bottom side of the first and second set of beams as shown in FIG. 19 with reference to the mounting system 100.

FIG. 23 shows a first mounting structure 102 of a mounting system 2300. The first mounting structure 102 shown in FIG. 23 is substantially similar to the first mounting structure 102 shown in FIG. 21, with the following exception(s). In FIG. 23, the processor 418 is coupled to a motor 2302 that turns two screws 2304 and 2306 along the X-axis. The motor 2302 may be coupled to a gear 2308 that is between the two screws 2304 and 2306 to rotate the two screws in a substantially similar manner. The gear 2308 may rotate the screw 2304 in a reverse manner relative to the screw 2306 such that the sleeves 2110 and 2112 may move in opposite direction along the X-axis at a substantially similar rate. In this embodiment, the sleeves 2110 and 2112 may be a bolt like element that is able to move along the X-axis as the screw turns. Moreover, with the two screws turning in opposite rotations, the two sleeves 2110 and 2112 may move either closer together or move away from each other. Alternatively, the threads on the two screws may be opposite of each other to move the two sleeves in the opposite direction. As such, the processor 418 may power the motor 2302 to move the sleeves 2110 and 2112 along the X-axis in opposite direction symmetrically in reference to the location of the gear 2308. With the mounting system 2300, the remote control 420 may be used to adjust the viewing angle of second mounting structure 104 in the following manner: (1) move the second mounting structure 104 laterally in the Y-axis; (2) tilt the second mounting structure 104 in the XZ plane, and (3) tilt the second mounting structure 104 in the YZ plane.

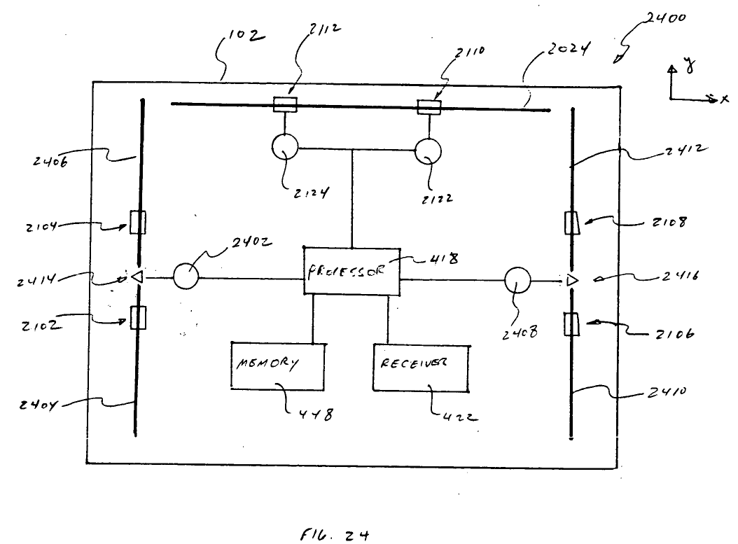

FIG. 24 shows a first mounting structure 102 of a mounting system 2400. The first mounting structure 102 shown in FIG. 24 is substantially similar to the first mounting structure 102 shown in FIG. 21, with the following exception(s). In FIG. 24 the processor 418 is coupled to a motor 2402 that turns two screws 2404 and 2406 along the Y-axis, and a motor 2408 that turns two screws 2410 and 2412. The motor 2402 may be coupled to a gear 2414 that is between the two screws 2404 and 2406 to rotate the two screws in a substantially similar manner. The gear 2414 may rotate the screw 2404 in a reverse manner relative to the screw 2406 such that the sleeves 2102 and 2104 may move in opposite direction along the Y-axis at a substantially similar rate. In other words, the two sleeves 2102 and 2104 may move either closer together or move away from each other along the Y-axis. Likewise, the motor 2408 may be coupled to a gear 2416 to move the sleeves in the opposite direction along the Y-axis. As such, the processor 418 may power the motor 2402 to move the sleeves 2102 and 2104 along the Y-axis in opposite directions symmetrically in reference to the location of the gear 2414. With the mounting system 2400, the remote control 420 may be used to adjust the viewing angle of second mounting structure 104 in the following manner: (1) move the second mounting structure 104 laterally in the X-axis; and (2) tilt the second mounting structure 104 in the YZ plane.

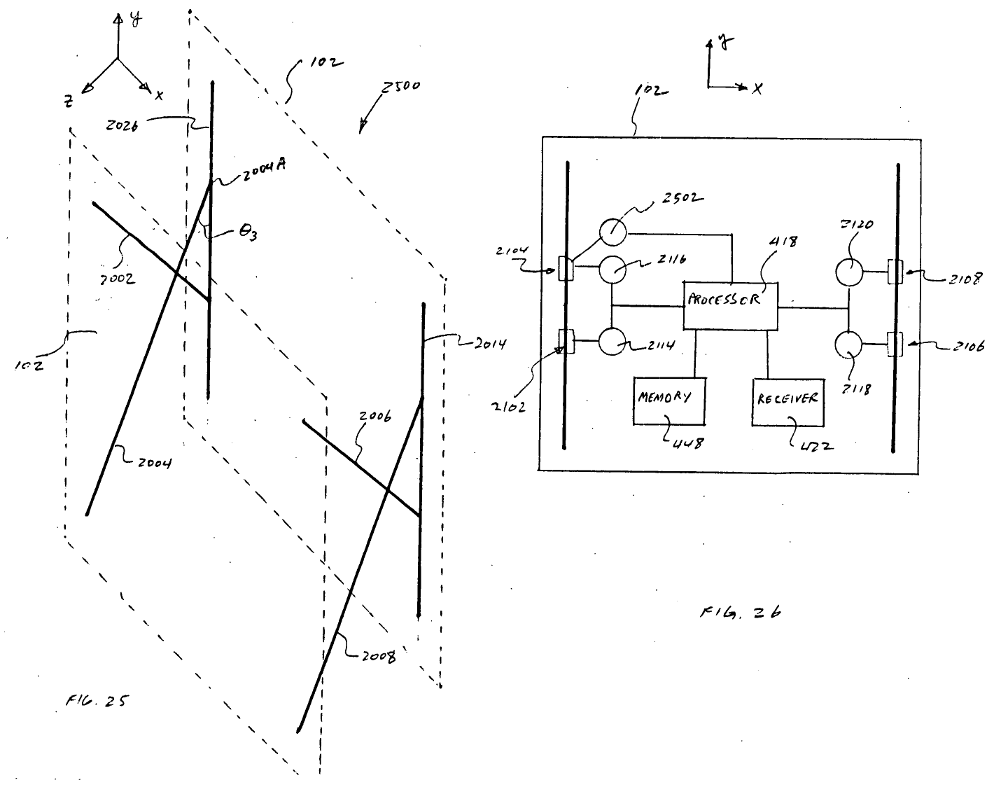

FIG. 25 shows a perspective view of a mounting system 2500 capable of adjustably mounting a second mounting structure 104 to a first mounting structure 102 with reference to X, Y, and Z axes, where the negative Y-axis generally represents the direction of gravity. The mounting system 2500 is substantially same as the mounting system 2000 but without the third set of beams 2010 and 2012. The mounting system 2500 may also include a motor 2502 to adjust the angle θ₃ between the beam 2004 and its respective guiding structure 2026. In this example, the sleeve 406 shown in FIG. 5C may be provided at the end 2004A of the beam 2004. FIG. 26 shows the processor 418 linked to the motor 2502 to adjust the angle θ₃ to tilt the second mounting structure 104 along the YZ plane. The extension of the first set of beams 2002 and 2004, and the second set of beams 2006 and 2008 may be adjusted to tilt the second mounting structure 104 along the XZ plane. In addition, the sleeves 2102 and 2104 corresponding to the first set of beams, and the sleeves 2106 and 2108 corresponding to the second set of beams may be adjusted along the Y-axis to move the second mounting structure in the positive or negative Y-axis.

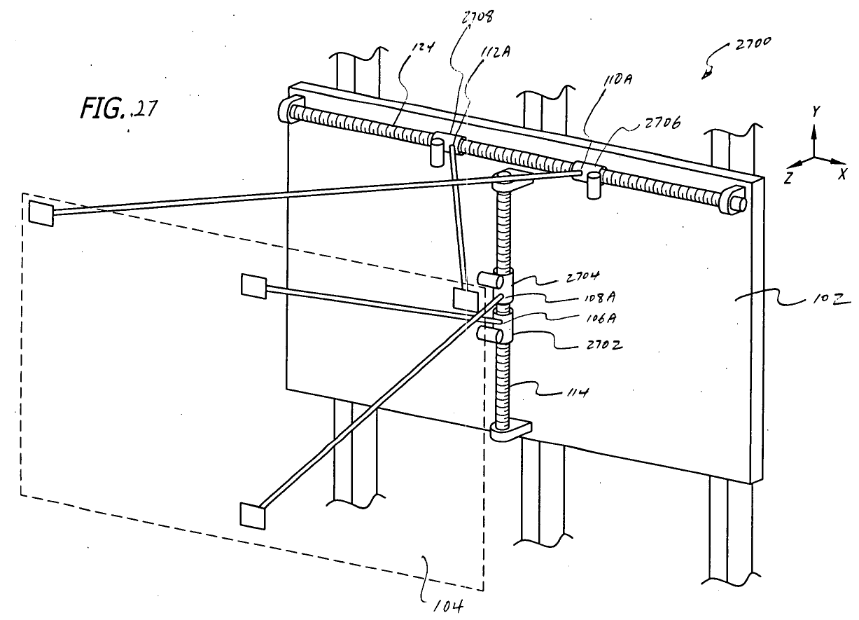

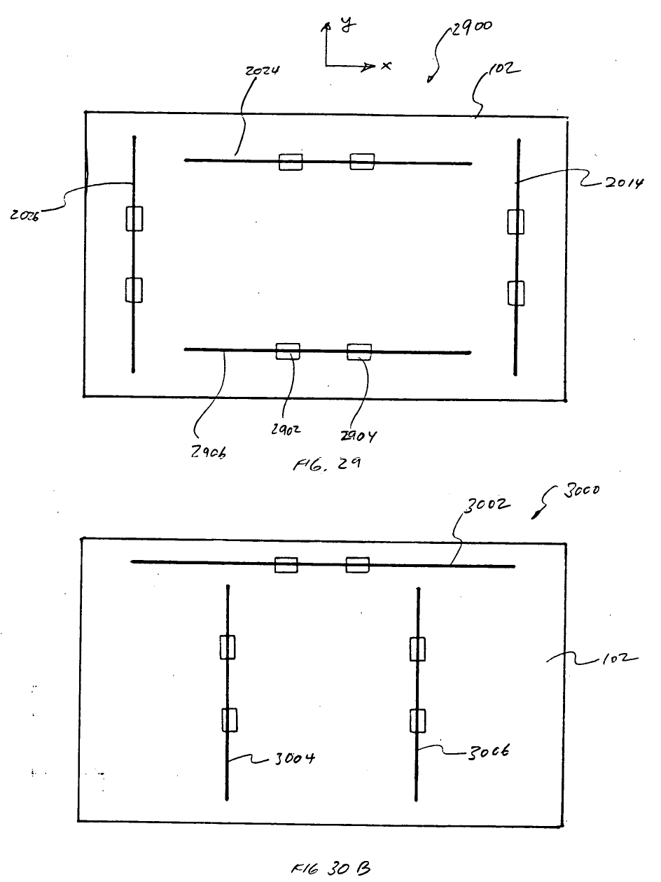

FIG. 27 shows a mounting system 2700 where the viewing angle of the second mounting structure 104 is adjusted manually rather than through the use of one or motors as discussed above. The first ends 106A, 108A, 110A, and 112A of the beams may be coupled to sleeves 2702, 2704, 2706, and 2708, respectively, that allows a user to manually move the sleeves along the respective guiding structure. For instance, FIGS. 28A and 28B show cross-sectional views of the sleeve 2704 capable of moving along the guiding structure 114. The sleeve 2704 includes a nut 500 within a housing 2706. The nut 500 may spin or rotate relative to the screw 114 to cause the sleeve 2704 to move along the Y-axis. The spinning direction of the nut 500, either in the clockwise or counter-clockwise direction around the screw 114, causes the sleeve 402 to move either in the positive or negative direction along the Y-axis. The nut 500 is coupled to a gear 2708 with a knob 2710. A user may turn the knob 2710 to rotate the gear 2708, which in turn turns the nut 500 around the screw 114. The housing 2706 may be also pivotally coupled to the first end 108A of the beam 108. As such, a user may manually move the sleeves 2702 through 2708 along their respective screws to adjust the viewing angle of the second mounting structure.

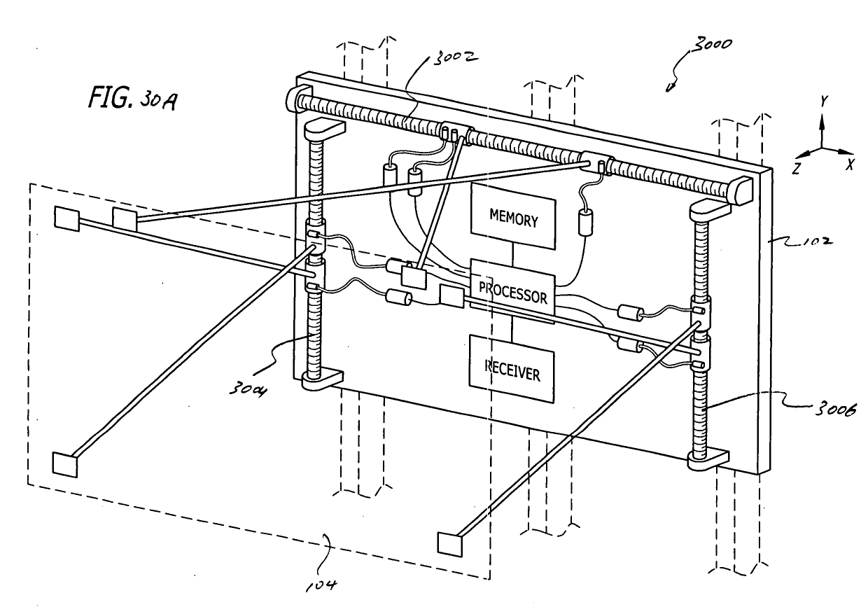

As illustrated above, a variety of different configurations of screws and sleeves may be provided with the first mounting structure 102. For instance, FIG. 29 shows a mounting system 2900 with a fourth set of sleeves 2902 and 2904 adapted to move along a guiding structure 2906. FIG. 30A shows a mounting system 3000 with an elongated guiding structure 3002 along the X-axis and two guiding structures 3004 and 3006 along the Y-axis. With the elongated guiding structure 3002 in the X-axis, the second mounting structure 104 may have more lateral movements in the X-axis. FIG. 30B shows the two guiding structures 3004 and 3006 closer together as compared to the two guiding structures 3004 and 3006 shown in FIG. 30A. Having the two guiding structures 3004 and 306 closer together may allow the second mounting structure 104 to have a greater degree of freedom to tilt in the XZ plane.

The mounting systems described above may be used for a variety of applications. For example, monitor, art piece, picture, speakers, camera, stereo equipments, and the like may be attached to the second mounting structure 104 to adjust the location of the item that is attached to the second mounting structure. The mounting system may be also used in a billboard application, where the viewing angle of the billboard may change as drivers passes by the billboard. Alternatively, the gravitational force may be in the negative Z direction such that the second mounting structure 104 may be adjusted to be substantially parallel to a floor. In this orientation, the mounting system may be used to lift and tilt the object provided on the second mounting structure. The mounting system may be also attached to a ceiling or other structures to move the second mounting structure in relative to the first mounting structure. With regard to mounting a monitor, the first mounting structure 102 may be a first plate with holes in order to attach the first plate the studs in the wall. Alternatively, the first mounting structure 102 may be the wall where the screws are provided on the wall. The second mounting structure 104 may be a second plate with holes to attach the second plate to the back side of the monitor. Alternatively, the second mounting structure 104 may be the back side of the monitor itself.

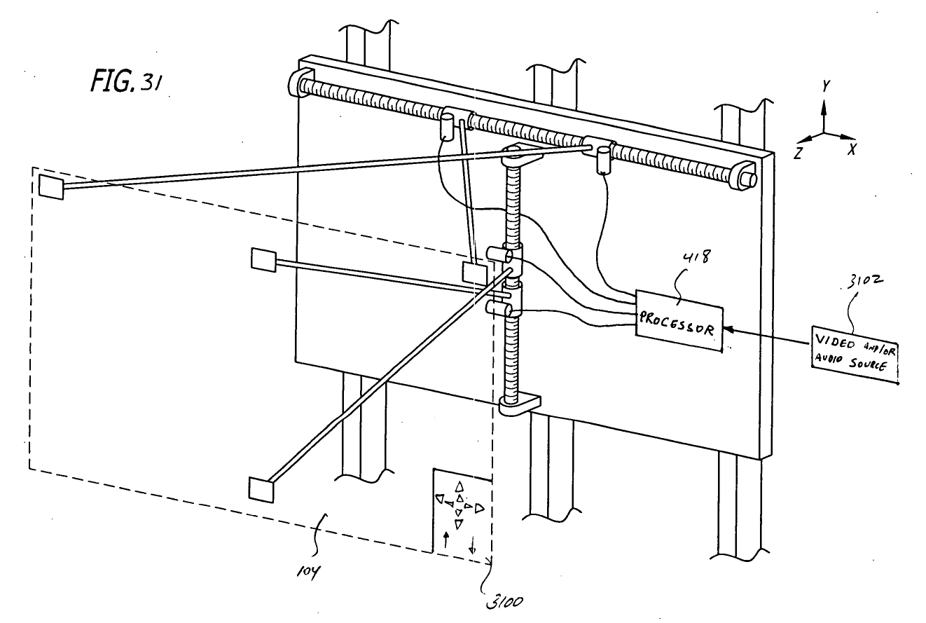

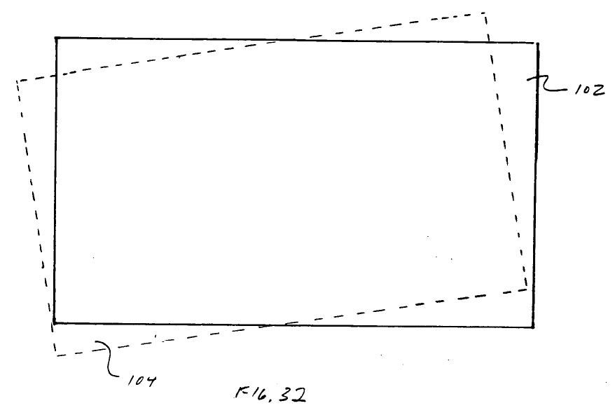

FIG. 31 shows that a control panel 3100 may be provided with the second mounting structure 104 to adjust the viewing angle. As such, even with heavier monitors attached to the second mounting structure 104, a user may adjust the viewing angle of the monitor through the control buttons on the control panel 3100. Alternatively, the input signals to the processor 418 may be provided by a video and/or audio source 3102 to control the viewing angle of the second mounting structure 104. In this application, the viewing angle of the second mounting structure 104 may be synchronized with the video shown through a monitor that is attached to the second mounting structure 104. For instance, at a predetermined time frame, the video scene in the monitor may show an actor walking from left to right or in the positive X direction. At the predetermined time frame, the video input data may also provide the input signal 424 to the processor to move the second mounting structure to the positive X direction, as illustrated in reference to FIG. 9, thereby simulating the actor actually walking from left to right. In a different time frame, the video scene may show the actor turning to the right or turning in the clockwise direction in the XZ plane. In such a scene, the video input data may synchronize the actor's movement with the movement of the monitor by providing the input signal 436 to tilt the monitor in the clockwise direction in the XZ plane, thereby simulating the actor actually turning right.

In the interactive video game applications, the mounting system may be used to synchronize with the input data provided through the joystick used by a player. For example, with auto racing video games, as the player navigates a car through a race track with a joystick and as the car is driven through a turn that leans to the left or banks to the left, the second mounting structure 104 may tilt and twist as shown in FIG. 32, thereby simulating the actual turn in a real race track. In a gun fight video games, as the target climbs a ladder, i.e. the target is a moving target, the video game may provide an input signal 422 to move the monitor in the positive Y direction, as shown in FIG. 11, so that the player may shoot at a moving target rather than a target that is moving within a monitor that is fixed to a wall. In a flight simulating video games, as the player simulates taking off a runway, the video input signal may also provide an input signal 426 to simulate the window of the aircraft tilting as if the airplane is actually taking off the runway.

The mounting system may be also used move the second mounting structure 104 based on the audio input signal. For instance, the movement of the second mounting structure 104 may be based on the loudness level of the bass sound level of an audio input signal. In this regard, the processor 418 may measure the db level of the bass portion of the audio input signal, such as between about 20 Hz and about 100 Hz, and the second mounting structure 104 may move up and down based on the db level of the bass sound. In other words, the distance that the second mounting structure 104 moves up and down may be proportional to the db level of the bass sound. Alternatively, the second mounting structure 104 may move side to side or tilt depending on other aspects of the audio input signal. For example, the movement of the second mounting structure 104 may be proportional to the frequency level of the audio input. Alternatively, for digital audio signals, the audio signal may provide the input signals to the processor 418 to move the second mounting structure 104 to synchronize with the music.

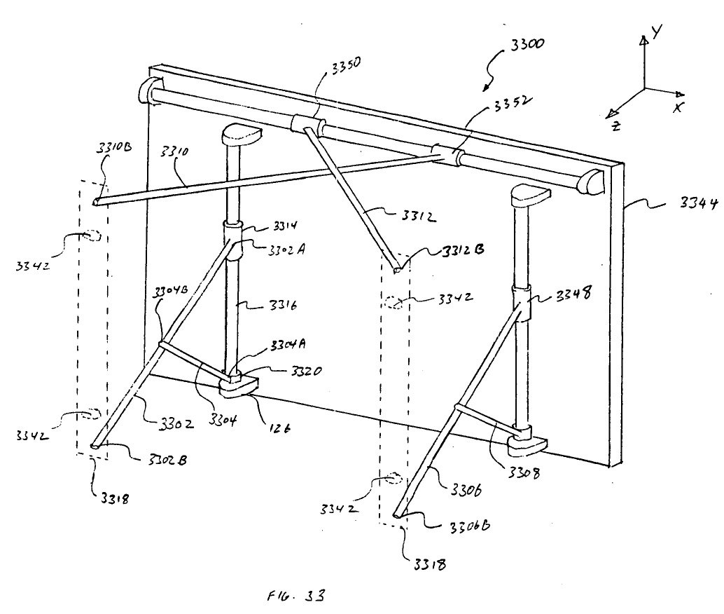

FIG. 33 shows a perspective view of a mounting system 3300 in reference to X, Y, and Z axes. The mounting system 3300 includes a first set of beams 3302 and 3304, a second set of beams 3306 and 3308, and a third set of beams,3310 and 3312. The third set of beams 3310 and 3312 may be substantially similar to the third set of beams 2010 and 2012 described above in reference to FIG. 20. In the first set of beams, the beam 3302 has two ends 3302A and 3302B, where the first end 3302A is pivotably coupled to a sleeve 3314 that is able to move along the guiding structure 3316. The first end 3302A may be coupled to the sleeve 3314 as discussed in reference to FIGS. 5A and 5B. The second end 3302B may be pivotably coupled to a bracket 3318, as described in more detail below. The second end 3310B of the beam 3310 may be also pivotably coupled to the bracket 3318 such that a line between the second ends 3302B and 3310B is substantially along the Y-axis. The beam 3304 has two ends 3304A and 3304B, where the first end 3304A may be pivotably coupled to a ring 3320. The second end 3304B may be pivotably coupled to the beam 3302 between the two ends 3302A and 3302B, such as at about the midpoint of the beam 3302, as described in more detail below. The second set of beams 3306 and 3308 may be coupled to each other, similar to the arrangement discussed in reference to the first set of beams 3302 and 3304.

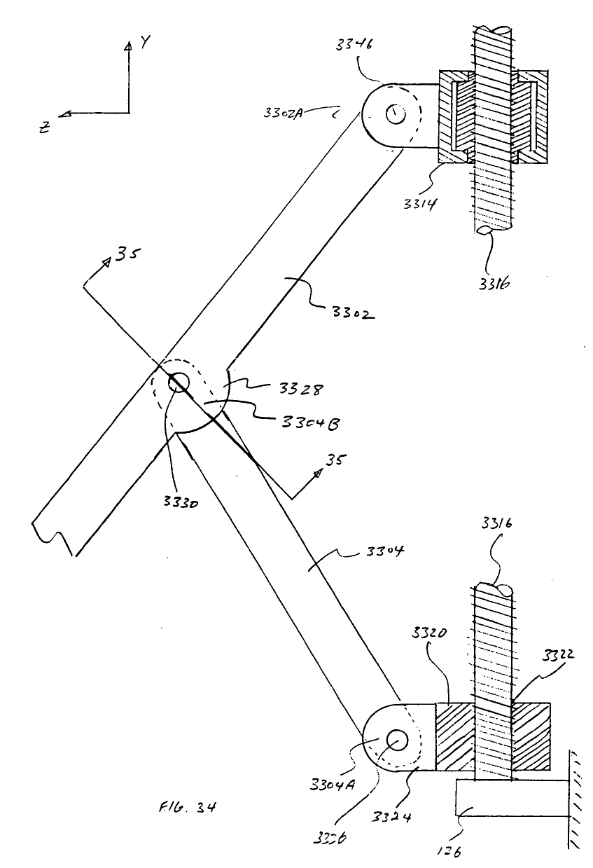

FIG. 34 shows a more detail view of the beam 3304 positioned between the beam 3302 and the ring 3320. The first end 3304A of the beam 3304 may be pivotably coupled to the ring 3320 and the second end 3304B may be pivotably coupled to the beam 3302. The ring 3320 may have a threaded opening 3320 adapted to receive the guiding structure 3316 represented as a screw in this example. The ring 3320 may have a flange 3324 adapted to couple the first end 3304A of the beam 3304 about a pivot point 3326 to allow the beam 3304 to pivot about the pivot point 3326. The beam 3302 may be provided with a flange 3328 adapted to couple the second end 3304B of the beam 3304 about a pivot point 3330 to allow the beam 3304 to pivot about the pivot point 3330. The flange 3328 may be formed about the midpoint of the beam 3302.

The first end 3302A of the beam 3302 is pivotably coupled to the sleeve 3314 at the pivot point 3346. As discussed above, the sleeve 3314 may be coupled to a motor such that when a processor provides power to the motor, the sleeve may move along the guiding structure 3316 either in the positive or negative direction along the Y-axis. Unlike the sleeve 3314, however, the ring may not be power by a motor so that the ring substantially maintains its position along the Y-axis. The ring, however, is able to rotate around the guiding structure 3316. The distance between the two pivot points 3326 and 3330 along the beam 3304, and the distance between the two pivot points 3330 and 3346 along the beam 3302 may be less than or equal to the length of the guiding structure 3316 so that when the sleeve 3314 is in the uppermost positive Y-axis direction, the beam 3302 may be substantially parallel with the guiding structure 3316 to retract the monitor. In addition, the distance between the two pivot points 3326 and 3330 along the beam 3304, and the distance between the two pivot points 3330 and 3346 along the beam 3302 may be substantially equal to each other. As discussed above, the pivot point 3330 may be located at about midpoint of the beam 3302. With the above pivoting arrangements, as the sleeve 3314 moves along the guiding structure 3316, the beams 3302 and 3304 pivot along their respective pivot points 3326, 3330, and 3346 to cause the second end 3302B to move substantially along the XZ plane, as discussed in more detail below.

FIG. 35 is a cross-sectional view of the pivot point 3330 along the line 35-35 in FIG. 34. The beams 3302 and 3304 may be aligned with respect to each other and the two beams 3302 and 3304 may be between the two flanges 3328. The second end 3304B may have an opening that aligns with the openings formed in the two flanges 3328 to receive a pin 3332 to allow the beam 3304 to pivot relative to the beam 3302 about the pivot axis 3330. As shown in FIG. 35, the shape of the beam 3302 may be configured to improve the moment of inertia with regard to the bending load along the YZ plane. In this example, the beam 3302 may have a rectangular configuration with the long side along the Y-axis.

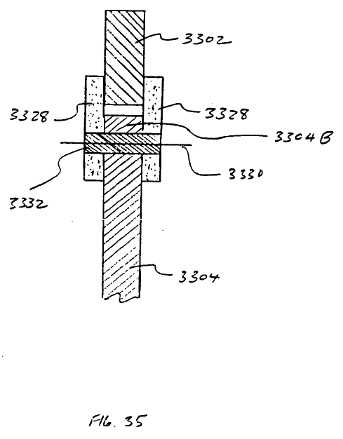

FIG. 36 is a perspective view of the bracket 3318 adapted to pivotably couple to the second ends 3302B and 3310B. The bracket 3318 may have a channel configuration adapted to provide a universal joint 600, as described above in reference to FIG. 6, at each of the pivot points to allow the second ends 3302B and 3310B to pivot relative to the bracket 3318. The bracket 3318 may have a base 3334 between two of its side walls 3336 and 3338. The two side walls 3336 and 3338 may have cavities 3340 to allow the universal joints 600 to pivot along the Y-axis without interfering with the side walls. Referring back to FIG. 33, the mounting system 3300 may have two brackets 3318 adapted to couple to the back side of a monitor where threaded holes are provided to attach to the two brackets with bolts. For instance, each bracket 3302 may have one or more bolt holes 3342 to attach a monitor to the two brackets 3318. With a monitor attached to the two brackets 3318, the mounting system 3300 is able to adjust the viewing angle of the monitor by adjusting the positions of two brackets 3302 relative to the first mounting structure 3344.

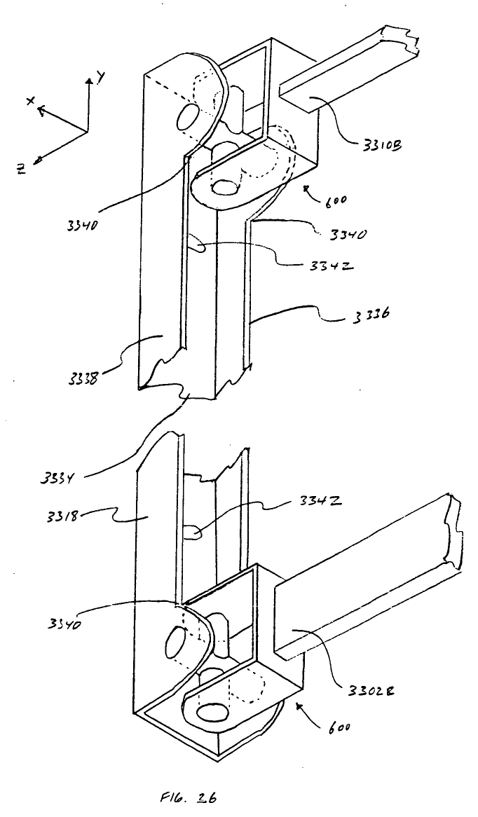

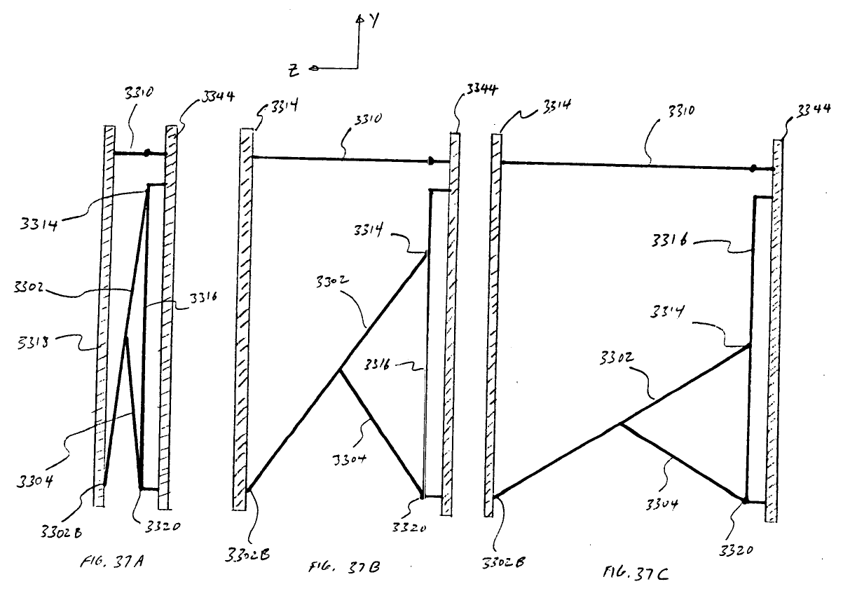

FIGS. 37A, 37B, and 37C show the first set of beams 3302 and 3304 extending from a first position, as shown in FIG. 37A, to an intermediate position, as shown in FIG. 37B, then to a second position, as shown in FIG. 37C. As discussed above, the beam 3304 may have a length “L” and the length of the beam 3302 may have a length 2L, and the beam 3304 may be pivotably coupled to the beam 3302 at about its midpoint. As the sleeve 3314 moves along the negative Y direction along the guiding structure 3316, the second end 3302B extends along the XZ plane. Note that with the above configuration, the second end 3302B substantially maintains its position along the Y-axis. Note that it is within the scope of this invention where the length of the beam is not 2 L and the beam 3304 is not pivotably coupled to the beam 3302 about its midpoint.

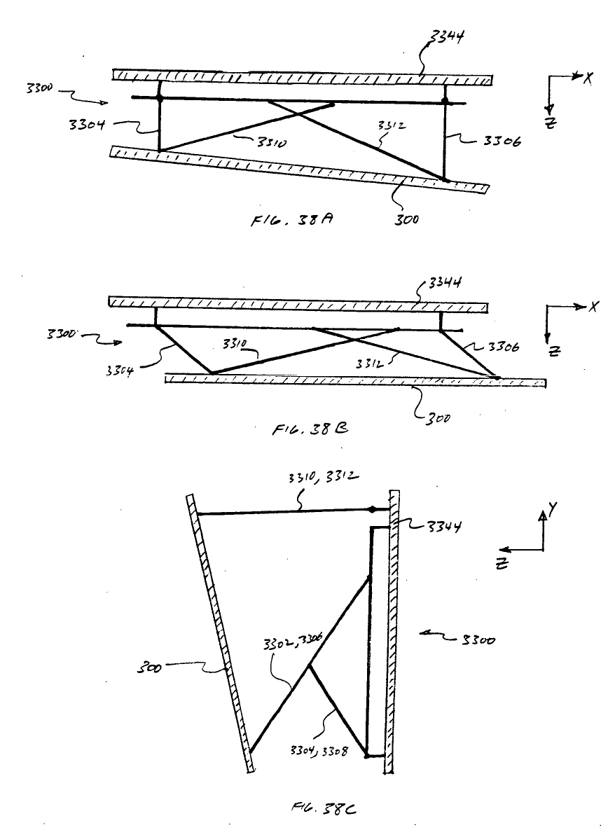

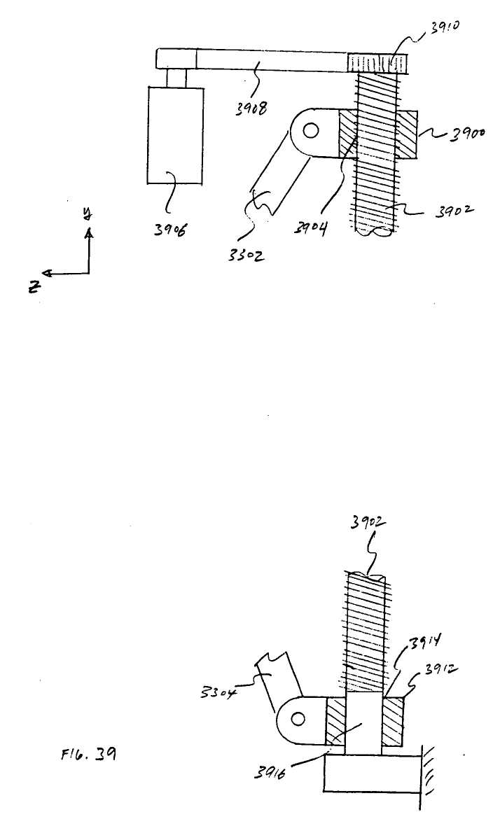

FIGS. 38A, 38B, and 38C show the mounting system 3300 adjusting the viewing angle of a monitor 300 in a number of orientations. FIG. 38A shows tilting the monitor 300 in the clockwise direction along the XZ plane by extending the beam 3306 further than the beam 3304. FIG. 38B shows moving the monitor 300 laterally in the positive X direction by moving the beams 3310 and 3312 in the positive X- direction. FIG. 38C shows the monitor 300 tilted in the counter-clockwise direction along the YZ plane by extending the beams 3310 and 3312 further than the beams 3302 and 3312. With the mounting system 3300, the viewing angle of the monitor 300 may be adjusted in a variety of ways by moving the sleeves 3314, 3348, 3350, and 3352, along their respective guiding structures. Note that in this example, four motors may be used to move the sleeves 3314, 3348, 3350, and 3352 along their respective guiding structures to: (1) extend and retract the monitor along the Z-axis relative to the first mounting structure 3344; (2) move the monitor laterally in the X direction; and (3) tilt the monitor 300 along the YZ plane and the XZ plane.

FIG. 39 shows an alternative way of moving a sleeve 3900 along a screw 3902. The sleeve 3900 may have a threaded opening 3904 to receive the screw 3902. The screw 3902 may be turned by a motor 3906 to cause the sleeve to move along the longitudinal axis of the screw 3902 or Y-axis. One end of the screw 3902 may have a gear 3910 and a chain 3908 may transfer the power from the motor 3906 to the screw 3902. The ring 3912 may have an opening 3914 that is substantially smooth to receive a smooth portion 3916 of the screw 3902. As such, as the screw rotates, the ring 3912 may substantially maintain its position along the Y-axis.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A mounting system capable of adjusting the viewing angle of a monitor, the mounting system including:
a first mounting structure;
a first guiding structure juxtaposed to the first mounting structure;
a second guiding structure juxtaposed to the first mounting structure and substantially perpendicular to the first guiding structure;
a first set of beams having a first beam and a second beam, each of the first and second beams having a first end and a second end, the first ends of the first and second beams adapted to move along the first guiding structure, the first and second beams diagonal with respect to each other and their second ends adapted to pivotally coupled to a second mounting structure; and
a second set of beams having a third beam and a fourth beam, each of the third and fourth beams having a first end and a second end, the first ends of the third and fourth beams adapted to move along the second guiding structure, the third and fourth beams diagonal with respect to each other and their second ends adapted to pivotally coupled to the second mounting structure where moving at least one of the first ends of the first, second, third, and fourth beams extend or retract their respective second ends to move the second mounting structure from a first position to a second position.

2. The mounting system according to claim 1, further including:
a third guiding structure juxtaposed to the mounting structure and substantially perpendicular to the first guiding structure;
a third set of beams having a fifth beam and a sixth beam, each of the fifth and sixth beams having a first end and a'second end, the first ends of the fifth and sixth beams adapted to move along the third guiding structure, the fifth and sixth beams diagonal with respect to each other and their second ends adapted to pivotally coupled to the second mounting structure, where moving the first ends of the fifth and sixth beams along the third guiding structure extend and retract their respective second ends to move the second mounting structure.

3. The mounting system according to claim 1, where each of the first ends of the first, second, third, and fourth beams is coupled to a motor to independently move the first ends along their respective first and second guiding structures.

4. The mounting system according to claim 1, where the first and second guiding structures are screws and each of the first ends of the first, second, third, and fourth beams is coupled to a sleeve adapted to move along its respective screw, and each of the sleeves is coupled to a motor to move the sleeves for the first ends of the first, second, third, and fourth beams along their respective screws.

5. The mounting system according to claim 4, the mounting system including:
a processor capable of controlling each of the motors to move their corresponding sleeves along their respective screws to adjust the viewing angle of the monitor;
a receiver coupled to the processor;
a remote control capable of sending control signals to the receiver to adjust the viewing angle of the monitor.

6. The mounting system according to claim 1, where the first mounting structure is adapted to couple to a wall.

7. The mounting system according to claim 1, where the second mounting structure is adapted to couple to a monitor.

8. A mounting system capable of adjusting the viewing angle of a monitor having a thickness, the mounting system comprising:
a first mounting structure adapted to couple to a wall;
a second mounting structure adapted to couple to a monitor;
a first set of beams between the first and second mounting structures, the first set of beams capable of extending and retracting the second mounting structure relative to the first mounting structure;
a second set of beams between the first and second mounting structures, the second set of beams capable of extending and retracting the second mounting structure relative to the first mounting structure; and
a third set of beams between the first and second mounting structures, the third set of beams capable of extending and retracting the second mounting structure relative to the first mounting structure, the first, second, and third set of beams capable extending the second mounting structure away from the first mounting structure a distance that is more than the thickness of the monitor and operate independently to adjust the viewing angle of the monitor.

9. The mounting system according to claim 8, where each of the first, second, and third sets of beams has two beams that are diagonal with respect to each other, each of the two beams for the first, second, and third sets of beams having a first end and a second end, the first ends of the first set of beams adapted to move along a first guiding structure, the first ends of the second set of beams adapted to move along a second guiding structure, the first ends of the third set of beams adapted to move along a third guiding structure, the third guiding structure substantially perpendicular to the first and second guiding structures, and moving at least one of the first ends of the two beams for the first, second, and third set of beams to extend or retract their respective second ends to move the second mounting structure to adjust the viewing angle of the monitor.

10. The mounting system according to claim 8, where the first, second, and third sets of beams are movably coupled to first, second, and third screws, respectively, the first, second, and third screws are juxtaposed to the first mounting structure, and the third screw is substantially perpendicular to the first and second screws.

11. The mounting system according to claim 10, where each of the first, second, and third sets of beams has first and second beams, the first and second beams having a first end and a second end, where the first and second sets of beams have:
the second ends of the second beams pivotally coupled to their respective first beams substantially about their midpoint,
the first ends of the first beams are adapted to move along their respective first and second screws,
the first ends of the second beams coupled to the first mounting structure to substantially rotate about the longitudinal axis of their respective screws, and
the second ends of the first beams of the first and second sets of beams pivotally coupled to the second mounting structure, where the third set of beams has:
the first and second beams diagonal with respect to each other and their second ends adapted to pivotally couple to the second mounting structure, where moving the first ends of the first and second beams along the third screw extend and retract their respective second ends to move the second mounting structure.

12. The mounting system according to claim 8, where each of the first, second, and third sets of beams are coupled to a motor to extend and retract the first, second, and third sets of beams.

13. The mounting system according to claim 12, the mounting system including:
a processor capable of controlling each of the motors to extend and retract their respective first, second, and third sets of beams;
a receiver coupled to the processor;
a remote control capable of sending control signals to the receiver to move the second mounting structure from a first position to a second position.

14. A remote control capable of interfacing with a motorized mounting system capable of adjusting the viewing angle of a monitor, the remote control comprising:
buttons to send control signals to the motorized mounting system to adjust the viewing angle of the monitor based on the control signals; and
a preset button capable of being programmed to send a preset control signal to the motorized mounting system to adjust the viewing angle of the monitor to a predetermined position.

15. The remote control according to claim 14, where the buttons include tilt buttons to tilt the monitor along a first plane and a second plane.

16. The remote control according to claim 14, where the buttons include lateral buttons to move the monitor laterally side to side and up and down.

17. A method of adjusting the viewing angle of a monitor relative to a wall, the monitor having a thickness, the method comprising:
receiving a control signal to adjust the viewing angle of the monitor along a first plane and/or a second plane;
if the monitor is substantially against the wall, then extending the monitor away from the wall a distance that is more than the thickness of the monitor; and
tilting the monitor along the first plane and/or the second plane based on the control signal to adjust the viewing angle of the monitor.

18. The method according to claim 17, including:
extending the monitor from the wall in a substantially parallel manner with the wall.

19. The method according to claim 17, including:
moving the monitor laterally relative to the wall.

20. The method according to claim 19, including:
moving the monitor vertically relative to the wall.

21. The method according to claim 17, where the first plane is substantially along a horizontal plane and the second plane is substantially along a vertical plane.

22. A method of remotely of interfacing with a motorized mounting system capable of adjusting the viewing angle of a monitor, the method comprising:
sending a control signal to the motorized mounting system to adjust the viewing angle of the monitor based on the control signal; and
programming a preset button to send a preset control signal to the motorized mounting system to adjust the viewing angle of the monitor to a predetermined position.

23. The method according to claim 22, where the control signal is a tilt signal to adjust the viewing angle of the monitor substantially along a horizontal plane.

24. The method according to claim 22, where the control signal is a tilt signal to adjust the viewing angle of the monitor substantially along a vertical plane.

25. The method according to claim 22, where the control signal is a lateral signal to move the monitor laterally side to side.

26. The method according to claim 22, where the control signal is a lateral signal to move the monitor laterally up or down.
